(19) United States
(12) Patent Application Publication
(10) Pub. No.: US 2026/0222855 A1
(43) Pub. Date: Jul. 30, 2026

(54) COMMUNICATION SENSING METHOD AND DEVICE, AND STORAGE MEDIUM

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 19/148,302

(22) PCT Filed: Jan. 16, 2023
(86) PCT No.: PCT/CN2023/072454

§ 371 Date: Jul. 15, 2025

(51) Int. Cl. H04W 24/08

(52) U.S. Cl. CPC H04W 24/08

(57) ABSTRACT

The present disclosure relates to a communication sensing method, apparatus and device, and a storage medium. The method comprises: determining a sensing node; and using the sensing node to transmit a sensing signal, wherein the sensing signal is used for sensing a sensing target. According to the present disclosure, a sensing node suitable for transmitting a sensing signal is determined, so that the determined sensing node is used for performing sensing, thereby improving the accuracy for sensing a sensing target.

### CROSS-REFERENCE TO RELATED APPLICATIONS

The present application is a U.S. National Stage of International Application No. PCT/CN2023/072454, filed on Jan. 16, 2023, the contents of which are incorporated herein by reference in their entirety for all purposes.

### BACKGROUND OF THE INVENTION

Currently, a communication sensing technology is studied, and its main scenarios include a sensing node and a sensed target. The sensed target may be an object that needs to be sensed, such as a vehicle or a building. The sensing node may be a node that needs to sense the sensed target by at least one of sending a sensing signal or receiving the sensing signal. For example, the sensing node may be a base station, a mobile phone, an on-board device, etc. The sensing node wants to sense information such as a position of the sensed target from the sensing node.

### SUMMARY OF THE INVENTION

The present disclosure relates to the field of communication technology, in particular to a communication sensing method and device, and a storage medium.

According to a first aspect of embodiments of the present disclosure, a communication sensing method is provided, performed by a terminal, including: determining a sensing node; and transmitting a sensing signal by using the sensing node, where the sensing signal is configured to sense a sensed target.

According to a second aspect of the embodiments of the present disclosure, a communication sensing method is provided, performed by an access network device, including: determining a sensing node; and transmitting a sensing signal by using the sensing node, where the sensing signal is configured to sense a sensed target.

According to a third aspect of the embodiments of the present disclosure, a communication sensing device is provided, including: one or more processors; and a memory that stores processor-executable instructions, where the processor-executable instructions, when collectively executed by the one or more processors, cause the communication sensing device to: determine a sensing node; and transmit a sensing signal by using the sensing node, where the sensing signal is configured to sense a sensed target.

According to a fourth aspect of the embodiments of the present disclosure, a non-transitory computer-readable storage medium including Instructions is provided. The instructions, when executed by a processor of the terminal, cause the terminal to perform the first aspect and any method of the first aspect.

It is to be understood that the general descriptions herein and later detailed descriptions are merely examples and illustrative, and cannot limit the present disclosure.

### BRIEF DESCRIPTION OF DRAWINGS

Accompanying drawings here are incorporated into the specification, constitute a part of the specification, show embodiments consistent with the present disclosure, and are used to explain a principle of the present disclosure together with the specification.

FIG. 1 is a schematic diagram of a wireless communication system according to an example.

FIG. 2 is a flowchart of a communication sensing method according to an example.

FIG. 3 is a flowchart of a communication sensing method according to another example.

FIG. 4 is a flowchart of a communication sensing method according to yet another example.

FIG. 5 is a flowchart of a communication sensing method according to yet another example.

FIG. 6 is a schematic diagram of a communication sensing apparatus according to an example.

FIG. 7 is a schematic diagram of a communication sensing apparatus according to another example.

FIG. 8 is a schematic diagram of a communication sensing device according to an example.

FIG. 9 is a schematic diagram of a communication sensing device according to another example.

### DETAILED DESCRIPTION OF THE INVENTION

Examples are illustrated in detail here, and their instances are shown in accompanying drawings. When the following description refers to the accompanying drawings, unless otherwise indicated, the same numbers in different accompanying drawings indicate the same or similar elements. Implementations described in the following examples do not represent all implementations consistent with the present disclosure.

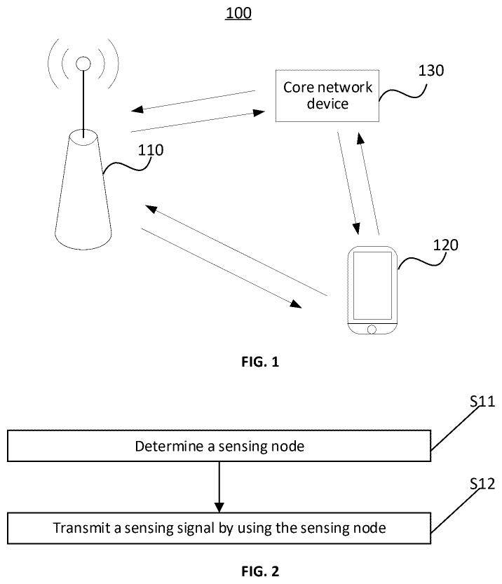

A communication method involved in the present disclosure may be applied in a wireless communication system 100 shown in FIG. 1. The wireless communication system may include an access network device 110, a terminal 120, and a core network device 130. It may be understood that the wireless communication system shown in FIG. 1 is merely for schematic illustration. Other network devices may further be included in the wireless communication system. For example, a wireless relay device, a wireless backhaul device, etc. may further be included, which are not shown in FIG. 1. An embodiment of the present disclosure does not limit the number of access network devices, the number of core network devices, and the number of terminals included in the wireless communication system.

It may be further understood that the wireless communication system of the embodiment of the present disclosure is a network that provides a wireless communication function. The wireless communication system may adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance. According to capacity, a rate, a delay, and other factors of different networks, the networks may be divided into a 2G (English: generation) network, a 3G network, a 4G network or a future evolved network, such as the 5th generation wireless communication system (5G) network. The 5G network may also be referred to as new radio (NR). For ease of description, the present disclosure sometimes refers to the wireless communication network simply as a network.

Further, the access network device 110 involved in the present disclosure may also include a wireless access network device. The wireless access network device may be: a base station, an evolved Node B (eNB), a home base station, an access point (AP) of a wireless fidelity (WIFI) system; a wireless relay node, a wireless backhaul node, a transmission point (TP) or a transmission and receiving point (TRP), etc. The wireless access network device may further be a gNB in an NR system. Alternatively, the wireless access network device may further be a component or a part of the devices that constitute the base station, etc. In a case where the wireless communication system is a vehicle-to-everything (V2X) communication system, the access network device may further be an on-board device. It is to be understood that a specific technology and specific device form adopted for the access network device are not limited to the embodiment of the present disclosure.

Further, the terminal 120 involved in the present disclosure may also be referred to as a terminal device, a user equipment (UE), a mobile station (MS), a mobile terminal (MT), etc. The terminal is a device that provides at least one of voice or data connectivity to a user. For example, the terminal may be a handheld device with a wireless connection function, an on-board device, etc. At present, some examples of the terminal are: a mobile phone, a pocket personal computer (PPC), a palmtop, a personal digital assistant (PDA), a laptop, a tablet, a wearable device, or an on-board device, etc. In a case where the wireless communication system is the V2X communication system, the terminal device may further be the on-board device. It is to be understood that a specific technology and specific device form adopted for the terminal are not limited to the embodiment of the present disclosure.

The core network device 130 involved in the present disclosure may include: a mobile management entity (MME) and a serving gateway (S-GW) in long-term evolution (LTE), etc.; a corresponding service general packet radio service support node (SGSN) and a gateway general packet radio service support node (GGSN) in 3G, etc.; a next generation-core (NG-Core) in 5G; and a sensing function entity in the present disclosure, etc. It is to be understood that a specific technology and specific device form adopted for the core network device are not limited to the embodiment of the present disclosure.

In the embodiment of the present disclosure, mutual data transmission may be implemented by adopting any feasible wireless communication technology by the access network device 110 and the terminal 120. A transmission channel used by the access network device 110 to send data or control information to the terminal 120 is referred to as a downlink (DL) channel. A transmission channel used by the terminal 120 to send data or control information to the access network device 110 is referred to as an uplink (UL) channel. It may be understood that the access network device involved in the embodiment of the present disclosure may be the base station. The access network device may be any other possible access network device, and the terminal may be any possible terminal, which is not limited to the present disclosure.

Mutual data transmission may be implemented by adopting any feasible wireless communication technology between the access network device 110 and the core network device 130, as well as between the terminal 120 and the core network device 130. The core network device may be any other possible core network device, which is not limited to the present disclosure.

Currently, a communication sensing technology is studied, and its main scenarios include a sensing node and a sensed target. The sensed target may be an object that needs to be sensed, such as a vehicle or a building. The sensing node may be a node that needs to sense the sensed target by at least one of sending a sensing signal or receiving the sensing signal. For example, the sensing node may be the access network device, the mobile phone, the on-board device, etc. The sensing node wants to sense information such as a position of the sensed target from the sensing node, for example, a distance, an angle, and a mobile speed.

A sensing mode for sensing the sensed target may include the following six modes. Corresponding sensing nodes are also different in different modes.

The sensing node is between access network devices, including sensing mode 1 and sensing mode 2.

Sensing mode 1 involves the access network device performing self-sending and self-receiving. For example, the gNB sends the sensing signal, the sensing signal is reflected after arriving at the sensed target, and the gNB further receives the reflected sensing signal.

Sensing mode 2 involves transmitting the sensing signal between different access network devices. For example, a gNB A sends the sensing signal, which is reflected after arriving at the sensed target, and a gNB B receives the reflected sensing signal.

The sensing node is between terminals, including sensing mode 3 and sensing mode 4.

Sensing mode 3 involves the terminal performing the self-sending and self-receiving. For example, the UE sends the sensing signal, the sensing signal is reflected after arriving at the sensed target, and the UE further receives the reflected sensing signal.

Sensing mode 4 involves transmitting the sensing signal between different terminals. For example, a UE A sends the sensing signal and a UE B receives the sensing signal. For example, the UE A sends the sensing signal, the sensing signal is reflected after arriving at the sensed target, and the UE B receives the reflected sensing signal.

The sensing node is between the access network device and the terminal, including a sensing mode 5 and a sensing mode 6.

Sensing mode 5 involves the UE sending the sensing signal and the gNB receiving the sensing signal. For example, the UE sends the sensing signal, the sensing signal is reflected after arriving at the sensed target, and the gNB receives the reflected sensing signal.

Sensing mode 6 involves the gNB sending the sensing signal, and the UE receiving the sensing signal. For example, the gNB sends the sensing signal and the UE receives the sensing signal. For example, the gNB sends the sensing signal, the sensing signal is reflected after arriving at the sensed target, and the UE receives the reflected sensing signal.

However, a plurality of different sensing modes exist currently. Sensing nodes may be different in different modes. However, there is, currently, no relevant method for determining sensing nodes under various models. In other words, there is currently no relevant solution on how to determine the sensing node that sends the sensing signal for sensing the sensed target.

At present, for different sensing modes, how to determine the sensing node that sends the sensing signal and how to determine the sensing node that receives the sensing signal are problems that need to be solved.

Accordingly, a communication sensing method, apparatus, and device, and a storage medium are provided by the present disclosure. A sensing node suitable for transmitting a sensing signal is determined, so that sensing is performed by using the determined sensing node, thus improving accuracy for sensing a sensed target.

FIG. 2 is a flowchart of a communication sensing method according to an example. As shown in FIG. 2, the method is performed by the terminal and may include the following steps.

In step S11, a sensing node is determined.

In some implementations, the terminal may determine the sensing node. For example, the terminal may determine at least one of: a sensing node configured to send the sensing signal; or a sensing node configured to receive the sensing signal.

The sensing node may be the terminal or the access network device.

In step S12, the sensing signal is transmitted by using the sensing node.

In some embodiments, the terminal may transmit the sensing signal by using the sensing node determined in S11. For example, the sensing signal may be sent, received or both. The sensing signal is configured to sense the sensed target.

It may be understood that the sensed target may be sensed by receiving the sensing signal and determining a corresponding measurement result. The measurement result is a sensing result obtained by sensing the sensed target.

According to the present disclosure, the sensing node suitable for transmitting the sensing signal is determined, so that sensing is performed by using the determined sensing node, thus improving accuracy for sensing the sensed target.

In the communication sensing method provided by the embodiment of the present disclosure, FIG. 3 is a flowchart of a communication sensing method according to another example. As shown in FIG. 3, in a case where the sensing node is the terminal, determining the sensing node in S11 may further include the following steps.

In step S21, the sensing signal or a reference signal sent by the access network device or other terminal is received.

In some embodiments, the terminal may receive the sensing signal sent by the access network device or the other terminal. Alternatively, the terminal may receive the reference signal sent by the access network device or the other terminal.

For example, the terminal may receive the sensing signal or the reference signal sent by the access network device. The reference signal may be a synchronization signal and physical broadcast channel block (SSB), a channel-state information reference signal (CSI-RS), a demodulation reference signal (DMRS), etc. The reference signal may also be specifically used to determine the sensing node. It may be understood that the present disclosure does not limit a specific form of the reference signal.

It may be understood that in a case where the terminal receives the sensing signal or the reference signal sent by the other terminal, the sensing signal is a sensing signal of a sidelink, and the reference signal is a reference signal of the sidelink. The reference signal of the sidelink may be a sidelink SSB, a sidelink CSI-RS, a sidelink DMRS, a sidelink sounding reference signal (SRS), etc.

For example, a resource configuration of the sensing signal or the reference signal may be indicated by the sensing function entity. Alternatively, the resource configuration of the sensing signal or the reference signal may be broadcast by the access network device. Afterwards, the other terminal or the access network device may send the sensing signal or the reference signal on a corresponding resource based on the resource configuration of the sensing signal or the reference signal. For example, the sensing signal or the reference signal may be sent via omni-directional broadcast, or broadcast based on a specific beam.

In step S22, a performance of the sensing signal or a performance of the reference signal is determined.

In some embodiments, the terminal may determine the performance of the sensing signal or the performance of the reference signal by measuring the sensing signal or the reference signal.

For example, the performance may be a signal quality, a signal strength, etc.

In step S23, the sensing node is determined based on the performance of the sensing signal or the performance of the reference signal meeting a performance condition.

In some embodiments, the terminal may determine whether the performance of the sensing signal meets the performance condition or determine whether the performance of the reference signal meets the performance condition. The terminal determines the sensing node based on the performance of the sensing signal or the performance of the reference signal meeting the performance condition.

For example, in a case where the terminal receives the sensing signal, the terminal may determine that it is the sensing node based on the performance of the sensing signal meeting the performance condition. For another example, in a case where the terminal receives the reference signal, the terminal may determine that it is the sensing node based on the performance of the reference signal meeting the performance condition.

The performance condition may be, for example, some preset thresholds.

In some embodiments, if the terminal receives the sensing signal, it may directly determine that itself is the sensing node based on a feature of the sensing signal meeting a corresponding condition.

For example, the terminal receives the sensing signal. The features, such as signal strength and signal quality of the sensing signal, meet preset corresponding conditions. For example, the signal strength of the sensing signal is greater than a certain preset signal strength threshold, and the signal quality is greater than or equal to a certain preset signal quality threshold, etc. Thus, the terminal may directly determine that it is the sensing node.

According to the present disclosure, the sensing node suitable for transmitting the sensing signal is determined based on the performance situation of the sensing signal or the reference signal. Sensing is performed using the determined sensing node, thus improving the accuracy of sensing the sensed target.

In the communication sensing method provided by the embodiment of the present disclosure, the performance condition may be determined based on at least one of the following: configuration information received from the sensing function entity; configuration information received from the access network device; or a default rule.

In some embodiments, the terminal may receive the configuration information from the sensing function entity to determine the performance condition.

For example, the terminal receives the configuration information sent by the sensing function entity, e.g., sent in broadcast form or unicast form, and determines at least one of the performance of the sensing signal or the performance of the reference signal.

In some embodiments, the terminal may receive the configuration information from the access network device to determine the performance condition.

For example, the terminal receives the configuration information sent by the access network device, e.g., sent by the gNB in the broadcast form or in the unicast form, and determines at least one of the performance of the sensing signal or the performance of the reference signal.

In some embodiments, the terminal may determine the performance condition based on the default rule.

For example, the default rule may be a rule that is pre-specified in a protocol, or pre-configured, etc.

In some embodiments, the terminal may receive the configuration information from the sensing function entity to determine the performance condition; and the terminal may receive the configuration information from the access network device to determine the performance condition. Alternatively, the terminal may receive the configuration information from the sensing function entity to determine the performance condition; and the terminal may determine the performance condition based on the default rule. Alternatively, the terminal may receive the configuration information from the access network device to determine the performance condition; and the terminal may determine the performance condition based on the default rule. Alternatively, the terminal may receive the configuration information from the sensing function entity to determine the performance condition; the terminal may receive the configuration information from the access network device to determine the performance condition; and the terminal may determine the performance condition based on the default rule.

The present disclosure provides a plurality of methods for determining the performance condition so that the terminal determines the sensing node suitable for transmitting the sensing signal according to the performance condition. As a result, sensing may be performed by using the determined sensing node, thus improving the accuracy of sensing the sensed target.

In the communication sensing method provided by the embodiment of the present disclosure, the sensing node includes at least one of a sensing signal sending node or a sensing signal receiving node. The terminal is at least one of the sensing signal sending node or the sensing signal receiving node.

In some embodiments, the sensing node may include the sensing signal sending node. The terminal may be the sensing signal sending node.

It may be understood that the sensing signal sending node is a node configured to send the sensing signal.

In some embodiments, the sensing node may include the sensing signal receiving node. The terminal may be the sensing signal receiving node.

It may be understood that the sensing signal receiving node is a node configured to receive the sensing signal.

In some embodiments, the sensing node may include the sensing signal sending node and the sensing signal receiving node. The terminal may be the sensing signal sending node and the sensing signal receiving node.

The terminal in the present disclosure may be at least one of the sensing signal sending node or the sensing signal receiving node. As a result, sensing may be performed by using the determined sensing node, thus improving the accuracy of sensing the sensed target.

In the communication sensing method provided by the embodiment of the present disclosure, in a case where the terminal is the sensing signal receiving node, the method may further include: sending a sensing signal measurement result. The sensing signal measurement result may include at least one of the following: a sensing signal identifier; performance of the sensing signal; time of arrival of the sensing signal; an angle of the sensing signal; an angle of the sensed target; a speed of the sensed target; or a distance from the sensed target. The performance of the sensing signal; the time of arrival of the sensing signal, the angle of the sensing signal, the angle of the sensed target, the speed of the sensed target, and the distance from the sensed target are individual measured quantities. Each measured quantity may include at least one of the following: a maximum value, a minimum value, or granularity (i.e., resolution).

In some embodiments, in a case where the terminal is the sensing signal receiving node, the terminal may further send the sensing signal measurement result.

For example, the terminal, as the sensing signal receiving node, may receive and measure the sensing signal and obtain the sensing signal measurement result.

For example, the terminal may trigger sending, i.e., reporting, of the sensing signal measurement result based on some events. For example, the events may include: the signal strength of the sensing signal is greater than a signal strength threshold; the angle of the sensing signal is greater than or equal to a first angle threshold; the angle of the sensing signal is less than or equal to a second angle threshold; a delay of the sensing signal is less than a delay threshold; the distance from the sensed target is less than a distance threshold, and other possible situations. The sending of the sensing signal measurement result may also be triggered based on more possible events according to an actual situation, which is not repeated in the present disclosure.

In some embodiments, the sensing signal measurement result may include a sensing signal identifier.

The identifier may be an identity (ID) identifier or an index.

In some embodiments, the sensing signal measurement result may include the performance of the sensing signal.

For example, the performance may be the signal strength, the signal quality, etc.

In some embodiments, the sensing signal measurement result may include the time of arrival of the sensing signal.

In some embodiments, the sensing signal measurement result may include the angle of the sensing signal.

For example, the angle of the sensing signal may include at least one of an angle of arrival of the sensing signal or an angle of departure of the sensing signal.

In some embodiments, the sensing signal measurement result may include the angle of the sensed target.

For example, the angle of the sensed target includes at least one of an angle or a direction of the sensed target relative to the sensing node. For example, the sensed target is located 30 to 40 degrees southeast of the sensing node; the sensed target is located due north of the sensing node, etc.

In some embodiments, the sensing signal measurement result may include the speed of the sensed target.

For example, the speed of the sensed target includes at least one of a relative speed of the sensed target relative to the sensing node or an absolute speed of the sensed target. For example, the relative speed of the sensed target relative to the sensing node is 0. The absolute speed of the sensed target is 10 m/s. It may represent that the sensed target and the sensing node move in the same direction and at the same speed.

In some embodiments, the sensing signal measurement result may include the distance from the sensed target.

In some embodiments, the sensing signal measurement result may further include: the sensing signal identifier and the performance of the sensing signal; the time of arrival of the sensing signal, the angle of the sensing signal, the angle of the sensed target, the speed of the sensed target and the distance from the sensed target; the sensing signal identifier, the performance of the sensing signal, the time of arrival of the sensing signal, the angle of the sensing signal, the angle of the sensed target, and the speed of the sensed target; or the sensing signal identifier, the performance of the sensing signal, the time of arrival of the sensing signal, the angle of the sensing signal, the angle of the sensed target, the speed of the sensed target and the distance from the sensed target.

It may be understood that the sensing signal measurement result may also include any two, three, four, or five items, which are not enumerated in the present disclosure.

The terminal of the present disclosure may also report the sensing signal measurement result, and the plurality of possible parameters are provided, so that sensing may be performed by using the determined sensing node, thus improving the accuracy for sensing the sensed target.

In the communication sensing method provided by the embodiment of the present disclosure, the performance of the sensing signal is the signal strength or signal quality of the sensing signal, and the performance of the reference signal is the signal strength or signal quality of the reference signal.

In some embodiments, the performance of the sensing signal may be the signal strength of the sensing signal.

In some embodiments, the performance of the sensing signal may be the signal quality of the sensing signal.

For example, the signal strength may be at least one of layer 1 reference signal received power (L1-RSRP) or layer 3 reference signal received power (L3-RSRP).

For another example, the signal quality may be at least one of layer 1 signal to interference plus noise ratio (L1-SINR), layer 3 signal to interference plus noise ratio (L3-SINR), or layer 3 reference signal receiving quality (L3-RSRQ).

The present disclosure provides a plurality of possible parameters for the performance of the sensing signal so that sensing may be performed using the determined sensing node, thus improving the accuracy of sensing the sensed target.

In the communication sensing method provided by the embodiment of the present disclosure, the method may further include: transmitting a sensing request to at least one of the other terminal, the access network device, or the sensing function entity. Transmitting the sensing request may include at least one of sending the sensing request or receiving the sensing request. The sensing request is configured to request sensing the sensed target.

In some embodiments, the terminal may transmit the sensing signal request with the other terminal.

For example, the terminal may send the sensing request to the other terminal. The terminal may also receive the sensing request sent by the other terminal. The terminal may also send the sensing request to the other terminal and receive the sensing request sent by the other terminal. The sensing request is configured to sense the sensed target.

In some embodiments, the terminal may transmit the sensing signal request with the access network device.

For example, the terminal may send the sensing request to the access network device. The terminal may also receive the sensing request sent by the access network device. The terminal may also send the sensing request to the access network device and receive the sensing request sent by the access network device.

In some embodiments, the terminal may transmit the sensing signal request with the sensing function entity.

For example, the terminal may send the sensing request to the sensing function entity. The terminal may also receive the sensing request sent by the sensing function entity. The terminal may also send the sensing request to the sensing function entity and receive the sensing request sent by the sensing function entity.

In some embodiments, the terminal may also transmit the sensing request with the other terminal and the access network device; transmit the sensing request with the other terminal and the sensing function entity; transmit the sensing request with the access network device and the sensing function entity; and transmit the sensing request with the other terminal, the access network device and the sensing function entity.

The present disclosure provides a plurality of methods for transmitting the sensing request so that sensing may be performed using the determined sensing node, thus improving the accuracy of sensing the sensed target.

In the communication sensing method provided by the embodiment of the present disclosure, the sensing request includes at least one of a service cell identifier or a tracking identifier of the terminal.

In some embodiments, the service cell identifier of the terminal may be included in the sensing request.

For example, a service cell ID of the terminal is included in the sensing request.

In some embodiments, the tracking identifier of the terminal may be included in the sensing request.

For example, a tracking ID of the terminal is included in the sensing request.

In some embodiments, the service cell identifier and the tracking identifier of the terminal may be included in the sensing request.

It may be understood that the sensing request includes the above information, which may be configured to determine the sensing node. For example, according to the above information, it may be determined that all terminals in a certain cell are sensing nodes, or that an access network device in a certain service cell is the sensing node, etc.

The present disclosure provides possible parameters included in the sensing request, which may be configured to determine the sensing node. As a result, sensing may be performed by using the determined sensing node, thus improving the accuracy of sensing the sensed target.

In the communication sensing method provided by the embodiment of the present disclosure, sending the sensing request with the access network device based on at least one of the following: a random access procedure; a scheduling request; or an uplink medium access control control element (UL MAC CE).

In some embodiments, the terminal may send the sensing request to the access network device based on the random access procedure.

For example, there is an association relationship between the sensing request and any possible random access resource. The random access resource includes any one or more of a random access time-domain resource, frequency-domain resource, and random access preamble. In a case where the terminal initiates the random access based on a certain random access resource, it indicates to the access network device that the terminal sends the sensing request. Alternatively, the sensing request is carried in possible random access information, and the random access information carrying the sensing request is sent. For example, the sensing request is carried in a physical uplink shared channel (PUSCH) of a message (Msg) 3 or an Msg A during the random access procedure. A specific implementation process is not limited to the present disclosure.

In some embodiments, the terminal may send the sensing request to the access network device based on the scheduling request.

For example, there is an association relationship between the sensing request and any possible scheduling request resource. The scheduling request resource includes any one or more of a scheduling request time-domain resource, frequency-domain resource, cyclic code, and information block. In a case where the terminal sends the scheduling request based on a certain scheduling request resource, it indicates to the access network device that the terminal sends the sensing request. A specific implementation process is not limited to the present disclosure.

In some embodiments, the terminal may send the sensing request to the access network device based on the UL MAC CE.

For example, the terminal may send the sensing request along with any possible UL MAC CE to the access network device. For example, the sensing request is carried in a possible UL MAC CE, and the UL MAC CE carrying the sensing request is sent. The UL MAC CE may be an existing UL MAC CE, or a UL MAC CE specifically used to carry the sensing request. A specific implementation process is not limited to the present disclosure.

The present disclosure provides a plurality of methods for sending the sensing request with the access network device, and sensing is performed by using the determined sensing node, thus improving the accuracy for sensing the sensed target.

In the communication sensing method provided by the embodiment of the present disclosure, receiving the sensing request with the access network device based on at least one of the following: a first DL MAC CE; a paging signal; or first downlink control information (DCI).

In some embodiments, the terminal may receive the sensing request sent by the access network device based on the first DL MAC CE.

For example, the sensing request received by the terminal may be carried on the first DL MAC CE. The first DL MAC CE may be any possible DL MAC CE, which is not limited to the present disclosure. The first DL MAC CE may be an existing DL MAC CE, or a DL MAC CE specifically used to carry the sensing request. A specific implementation process is not limited to the present disclosure.

In some embodiments, the terminal may receive the sensing request sent by the access network device based on the paging signal.

For example, the sensing request received by the terminal may be carried on any possible paging signal. A specific implementation process is not limited to the present disclosure.

In some embodiments, the terminal may receive the sensing request sent by the access network device based on the first DCI.

For example, the sensing request received by the terminal may be carried on the first DCI. The first DCI may be any possible DCI, such as existing DCI or DCI specifically used to carry the sensing request. A specific implementation process is not limited to the present disclosure.

The present disclosure provides a plurality of methods for receiving the sensing request sent by the access network device. Sensing is performed using the determined sensing node, thus improving the accuracy of sensing the sensed target.

In the communication sensing method provided by the embodiment of the present disclosure, transmitting the sensing request with the other terminal based on at least one of the following: a sidelink broadcast channel; a first sidelink MAC CE; or first sidelink control information.

In some embodiments, the terminal may transmit the sensing request with the other terminal based on the sidelink broadcast channel.

For example, based on the sidelink broadcast channel, the terminal may perform at least one of the following: sending the sensing request to the other terminal, or receiving the sensing request. The sidelink broadcast channel is a physical sidelink broadcast channel (PBSCH).

In some embodiments, the terminal may transmit the sensing request with the other terminal based on the first sidelink MAC CE.

For example, based on the first sidelink MAC CE, the terminal may perform at least one of the following: sending the sensing request to the other terminal or receiving the sensing request. The first sidelink MAC CE may be an existing sidelink MAC CE, or a sidelink MAC CE specifically used to transmit the sensing request, which is not limited to the present disclosure.

In some embodiments, the terminal may transmit the sensing request with the other terminal based on the first sidelink control information.

For example, based on the first sidelink control information, the terminal may perform at least one of the following: sending the sensing request to the other terminal or receiving the sensing request. The sidelink control information may be referred to as sidelink control information (SCI). The sidelink control information may include SCI 1-A, SCI 2-A, SCI 2-B, SCI 2-C, and SCI specifically used to transmit the sensing request, other than the above types of SCI.

The present disclosure provides a plurality of methods for transmitting the sensing request with the other terminal, and sensing is performed by using the determined sensing node, thus improving the accuracy for sensing the sensed target.

In some implementations, the sensing request may be transmitted between the terminal and the sensing function entity by using specific signaling. Where the specific signaling may be signaling specifically used for information interaction with the sensing function entity.

In the communication sensing method provided by the embodiment of the present disclosure, in a case where the sensing node is the terminal, determining the sensing node in S11 includes: receiving indication information sent by the access network device, the other terminal, or the sensing function entity. The indication information is configured to indicate that the terminal is the sensing node.

In some embodiments, in a case where the sensing node is the terminal, the terminal may receive the indication information sent by the access network device. The indication information is configured to indicate that the terminal is the sensing node.

For example, the terminal may receive the indication information sent by the access network device and determine that it is the sensing node according to the indication information.

For example, the terminal may receive the indication information sent by the other terminal and determine that it is the sensing node according to the indication information.

For another example, the terminal may receive the indication information sent by the sensing function entity and determine that it is the sensing node according to the indication information.

The present disclosure may determine the sensing node via the indication information to be applicable to more scenarios. Sensing is performed using the determined sensing node, thus improving the accuracy of sensing the sensed target.

In the communication sensing method provided by the embodiment of the present disclosure, in a case where the indication information sent by the access network device or the sensing function entity is received, the indication information includes a cell identifier.

In some embodiments, in a case where the terminal receives the indication information sent by the access network device or the sensing function entity, the cell identifier may be included in the indication information.

For example, the terminal receives the indication information sent by the access network device, or the terminal receives the indication information sent by the sensing function entity. The cell identifier is included in the indication information. The terminal determines whether a cell where itself is located is a cell indicated by the cell identifier. Thus, it is possible to determine that the terminal is the sensing node in a case where the cell where the terminal is located is the cell indicated by the cell identifier.

According to the present disclosure, it is possible to indicate that the terminal is the sensing node via the cell identifier, so that sensing is performed by using the determined sensing node, thus improving the accuracy for sensing the sensed target.

In the communication sensing method provided by the embodiment of the present disclosure, in a case where the indication information sent by the access network device is received, the indication information includes at least one of the following: first broadcast information, where the first broadcast information includes: broadcast information carried on a physical broadcast channel (PBCH), or other system information carried on a physical downlink shared channel (PDSCH); a second DL MAC CE; or second downlink control information.

In some embodiments, in a case where the terminal receives the indication information sent by the access network device, the indication information may include the first broadcast information. The first broadcast information may include the broadcast information carried on the PBCH, or other system information carried on the PDSCH.

It may be understood that the indication information may be sent in the broadcast form to indicate that a corresponding device is the sensing node.

In some embodiments, in a case where the terminal receives the indication information sent by the access network device, the indication information may include the second DL MAC CE.

It may be understood that the second DL MAC CE may be sent in the unicast form to a designated device to indicate that the device is the sensing node. It may be understood that the second DL MAC CE and the first DL MAC CE may be the same DL MAC CE or different DL MAC CEs, which is not limited to the present disclosure.

In some embodiments, in a case where the terminal receives the indication information sent by the access network device, the indication information may include the second DCI.

It may be understood that the second DCI may be sent in the unicast form to the designated device to indicate that the device is the sensing node. It may be understood that the second DCI and the first DCI may be the same DCI or different DCIs, which is not limited to the present disclosure.

For example, the second DCI may be sent to a single user or to a plurality of users within one group. Paging and other downlink control information may be included in the second DCI. The paging in the embodiment may be the same paging as the paging for sending the sensing request, or may be different paging, which is not limited to the present disclosure.

The second DCI may be DCI format 0_0/0_1/0_2 for scheduling PUSCH, or DCI format 1_0/1_1/1_2 for scheduling PDSCH. The second DCI may further be group-based DCI format 2_0~2_7. The second DCI may further be DCI format 3_0/3_1 for the sidelink, or a new DCI format.

In some embodiments, the indication information may further include the first broadcast information and the second DL MAC CE; the first broadcast information and the second downlink control information; or the first broadcast information, the second DL MAC CE, and the second downlink control information.

The indication information of the present disclosure may include various information to support indicating the sensing node in various forms. As a result, sensing may be performed by using the determined sensing node, thus improving the accuracy of sensing the sensed target.

In the communication sensing method provided by the embodiment of the present disclosure, the first broadcast information is broadcast information corresponding to at least one SSB identifier.

In some embodiments, the first broadcast information may be broadcast information corresponding to the at least one SSB identifier.

For example, the SSB identifier may be an SSB ID.

The first broadcast information may be broadcast information corresponding to each SSB identifier. In other words, the broadcast information corresponding to each SSB identifier includes the above indication information. Then, a terminal within a beam coverage range corresponding to each SSB identifier may receive the indication information. While the first broadcast information may also be broadcast information corresponding to one or more designated SSB identifiers. In other words, the above indication information is included in the broadcast information corresponding to the one or more designated SSB identifiers. Then only the terminal within the beam coverage range corresponding to the one or more designated SSB identifiers may receive the indication information.

The present disclosure provides the form of expression of the first broadcast information to indicate the sensing node. As a result, sensing may be performed by using the determined sensing node, thus improving the accuracy for sensing the sensed target.

In the communication sensing method provided by the embodiment of the present disclosure, in a case where the terminal receives the indication information sent by the other terminal, the indication information includes at least one of the following: second broadcast information, where the second broadcast information includes: broadcast information carried on a PBCH of a sidelink, or other system information carried on a physical sidelink shared channel (PSSCH) of the sidelink; a second sidelink MAC CE; or second sidelink control information.

In some embodiments, in a case where the terminal receives the indication information sent by the other terminal, the indication information may include the second broadcast information. The second broadcast information may include the broadcast information carried on the PBCH of the sidelink, or other system information carried on the PSSCH of the sidelink.

It may be understood that the indication information may be sent in the broadcast form to indicate that a corresponding device is the sensing node.

In some embodiments, in a case where the terminal receives the indication information sent by the access network device, the indication information may include the second sidelink MAC CE.

It may be understood that the second sidelink MAC CE may be sent in the unicast form to the designated device to indicate that the device is the sensing node. It may be understood that the second sidelink MAC CE and the first sidelink MAC CE may be the same sidelink MAC CE or different sidelink MAC CEs, which is not limited to the present disclosure.

In some embodiments, in a case where the terminal receives the indication information sent by the access network device, the indication information may include the second sidelink control information.

It may be understood that the second sidelink control information may be sent in the unicast form to the designated device to indicate that the device is the sensing node. It may be understood that the second sidelink control information and the first sidelink control information may be the same sidelink control information or different sidelink control information, which is not limited to the present disclosure.

For example, the second sidelink control information may be sent to the single user or the plurality of users within one group.

The second sidelink control information may be SCI format 1-A, SCI format 2-A/2-B/2-C.

In some embodiments, the indication information may further include the second broadcast information and the second sidelink MAC CE; the second broadcast information and the second sidelink control information; or the second broadcast information, the second sidelink MAC CE, and the second sidelink control information.

The indication information of the present disclosure may include various information to support indicating the sensing node in various forms. As a result, sensing may be performed by using the determined sensing node, thus improving the accuracy for sensing the sensed target.

In the communication sensing method provided by the embodiment of the present disclosure, the second broadcast information is broadcast information corresponding to at least one sidelink SSB identifier.

In some embodiments, the second broadcast information may be broadcast information corresponding to at least one sidelink SSB identifier.

For example, the sidelink SSB is a sidelink synchronization signal and physical sidelink broadcast channel block. The sidelink SSB identifier may be a sidelink SSB ID.

The second broadcast information may be broadcast information corresponding to each sidelink SSB identifier. In other words, the broadcast information corresponding to each sidelink SSB identifier includes the above indication information. Then a terminal within a beam coverage range corresponding to each sidelink SSB identifier can receive the indication information. While the second broadcast information may also be broadcast information corresponding to one or more designated sidelink SSB identifiers. In other words, the above indication information is included in the broadcast information corresponding to the one or more designated sidelink SSB identifiers. Then only the terminal within the beam coverage range corresponding to the one or more designated sidelink SSB identifiers may receive the indication information.

The present disclosure provides the form of expression of the second broadcast information to indicate the sensing node. As a result, sensing may be performed by using the determined sensing node, thus improving the accuracy for sensing the sensed target.

In the communication sensing method provided by the embodiment of the present disclosure, the method further includes: sending the sensing signal or the reference signal. The sensing signal or the reference signal is configured to determine that the other terminal or the access network device is the sensing node.

In some embodiments, the terminal may further send the sensing signal or the reference signal. The sensing signal or the reference signal is configured to determine that the other terminal or the access network device is the sensing node.

The present disclosure provides a plurality of forms for determining the sensing node, so that sensing may be performed by using the determined sensing node, thus improving the accuracy for sensing the sensed target.

In the communication sensing method provided by the embodiment of the present disclosure, a sensing mode for performing sensing includes at least one of the following: determining the access network device as the sensing signal sending node, and determining the terminal as the sensing signal receiving node; determining the access network device as the sensing signal receiving node, and determining the terminal as the sensing signal sending node; determining a first terminal as the sensing signal sending node, and determining a second terminal as the sensing signal receiving node, where the terminal is the first terminal or the second terminal; or determining the terminal as the sensing signal sending node and the sensing signal receiving node.

In some embodiments, the sensing mode for performing sensing may include determining the access network device as the sensing signal sending node, and determining the terminal as the sensing signal receiving node.

For example, the sensing mode may be sensing mode 6.

In some embodiments, the sensing mode for performing sensing may include determining the access network device as the sensing signal receiving node, and determining the terminal as the sensing signal sending node.

For example, the sensing mode may be sensing mode 5.

In some embodiments, the sensing mode for performing sensing may include determining the first terminal as the sensing signal sending node, and determining the second terminal as the sensing signal receiving node, where the terminal is the first terminal or the second terminal.

For example, the sensing mode may be sensing mode 4. It may be understood that the first terminal and the second terminal may be different terminals.

In some embodiments, the sensing mode for performing sensing may include determining the terminal as the sensing signal sending node and the sensing signal receiving node.

For example, the sensing mode may be sensing mode 3.

The present disclosure is applicable to a plurality of different sensing mode scenarios to determine sensing nodes in the corresponding scenarios, so that sensing is performed by using the determined sensing node, thus improving the accuracy for sensing the sensed target.

Based on the same concept, the present disclosure further provides a sensing communication method performed on the access network device side.

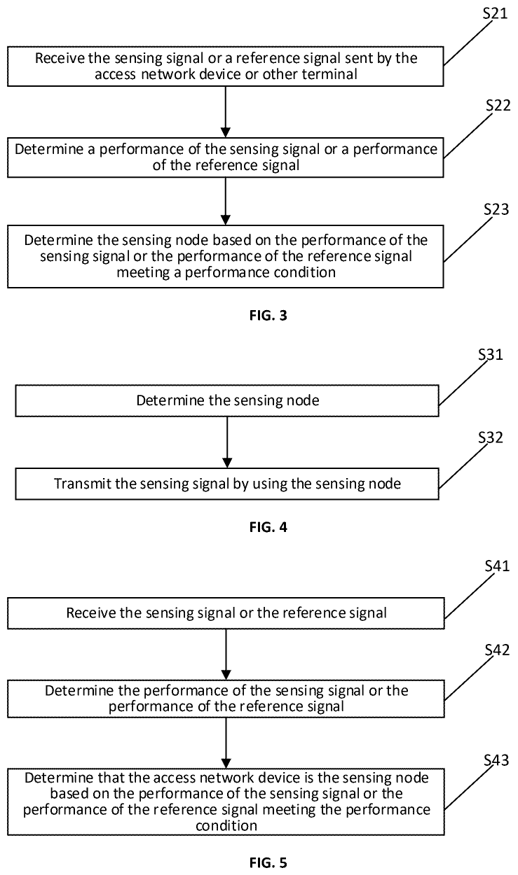

FIG. 4 is a flowchart of a communication sensing method according to yet another example. As shown in FIG. 4, the method is performed by the access network device and may include the following steps.

In step S31, the sensing node is determined.

In some implementations, the access network device may determine the sensing node.

For example, the access network device may determine at least one of: the sensing node configured to send the sensing signal; or the sensing node configured to receive the sensing signal.

The sensing node may be the terminal or the access network device.

In step S32, the sensing signal is transmitted by using the sensing node.

In some embodiments, the access network device may transmit the sensing signal using the sensing node determined in S31. The sensing signal may be sent, received, or both. It is configured to sense the sensed target.

It may be understood that the sensed target may be sensed by receiving the sensing signal and determining a corresponding measurement result. The measurement result is the sensing result obtained by sensing the sensed target.

According to the present disclosure, the sensing node suitable for transmitting the sensing signal is determined, so that sensing is performed by using the determined sensing node, thus improving accuracy for sensing the sensed target.

In the communication sensing method provided by the embodiment of the present disclosure, the sensing function entity or the access network device is a sensing initiating node, where the sensing initiating node is a node that sends the sensing request. The sensing request is configured to request sensing the sensed target.

In some implementations, the sensing function entity or the access network device may be the sensing initiating node. The sensing initiating node is the node which sends the sensing request. The sensing request may be configured to request sensing the sensed target by using the sensing node.

The present disclosure provides a plurality of forms of expression of the sensing initiating node, and the sensing request is sent so that sensing is performed by using the determined sensing node, thus improving the accuracy for sensing the sensed target.

In the communication sensing method provided by the embodiment of the present disclosure, in a case where the sensing node is the terminal, the method may further include: sending the sensing signal or the reference signal.

In some embodiments, in a case where the sensing node is the terminal, the access network device may send the sensing signal. Alternatively, the access network device may send the reference signal.

For example, the reference signal may be the SSB, the CSI-RS, the DMRS, etc. The reference signal may also be specifically used to determine the sensing node. It may be understood that the present disclosure does not limit a specific form of the reference signal.

For example, the resource configuration of the sensing signal or the reference signal may be indicated by the sensing function entity. Afterwards, the access network device may send the sensing signal or the reference signal on a corresponding resource based on the resource configuration of the sensing signal or the reference signal. For example, the sensing signal or the reference signal may be sent via the omni-directional broadcast, or broadcast based on the specific beam.

According to the present disclosure, the sensing node is determined by sending the sensing signal or the reference signal, so that sensing may be performed by using the determined sensing node, thus improving the accuracy for sensing the sensed target.

In the communication sensing method provided by the embodiment of the present disclosure, the method may further include: sending configuration information. The configuration information is configured to configure the performance condition. The performance condition is configured for the terminal to determine that the terminal is the sensing node based on the performance of the sensing signal or the performance of the reference signal meeting the performance condition.

In some embodiments, in a case where the sensing node is the terminal, the access network device may send the configuration information. The configuration information is configured to configure the performance condition. The performance condition may be, for example, some preset thresholds. Thus, the terminal may determine that the terminal is the sensing node based on the performance of the sensing signal or the performance of the reference signal meeting the performance condition.

For example, the access network device sends the configuration information to the terminal. The terminal may determine the performance of the sensing signal or the performance of the reference signal in a case where the terminal measures the sensing signal or the reference signal. Afterwards, the terminal may determine whether the performance of the sensing signal or the performance of the reference signal meets the performance condition configured according to the configuration information. For example, the performance may be signal quality, signal strength, etc. Furthermore, a corresponding sensing node is determined based on a case where the performance of the sensing signal or the performance of the reference signal meets the performance condition.

For example, in a case where the terminal receives the sensing signal, the terminal may determine that itself is the sensing node based on the performance of the sensing signal meeting the performance condition. For another example, in a case where the terminal receives the reference signal, the terminal may determine that itself is the sensing node based on the performance of the reference signal meeting the performance condition.

In some embodiments, if the terminal receives the sensing signal, it may directly determine that itself is the sensing node based on a feature of the sensing signal meeting a corresponding condition.

For example, the terminal receives the sensing signal. The features such as signal strength and signal quality of the sensing signal meet preset corresponding conditions. For example, the signal strength of the sensing signal is greater than a certain preset signal strength threshold, the signal quality is greater than or equal to a certain preset signal quality threshold, etc. Thus, the terminal may directly determine that it is the sensing node.

In some embodiments, the access network device may send the configuration information in the broadcast form or the unicast form.

According to the present disclosure, the sensing node suitable for transmitting the sensing signal is determined based on the performance situation of the sensing signal or the reference signal, so that sensing is performed by using the determined sensing node, thus improving the accuracy for sensing the sensed target.

In the communication sensing method provided by the embodiment of the present disclosure, the sensing node includes at least one of the sensing signal sending node or the sensing signal receiving node. The terminal is at least one of the sensing signal sending node or the sensing signal receiving node.

In some embodiments, the sensing node may include the sensing signal sending node. The terminal may be the sensing signal sending node.

It may be understood that the sensing signal sending node is the node configured to send the sensing signal.

In some embodiments, the sensing node may include the sensing signal receiving node. The terminal may be the sensing signal receiving node.

It may be understood that the sensing signal receiving node is the node configured to receive the sensing signal.

In some embodiments, the sensing node may include the sensing signal sending node and the sensing signal receiving node. The terminal may be the sensing signal sending node and the sensing signal receiving node.

The terminal of the present disclosure may be at least one of the sensing signal sending node or the sensing signal receiving node. As a result, sensing may be performed by using the determined sensing node, thus improving the accuracy for sensing the sensed target.

In the communication sensing method provided by the embodiment of the present disclosure, in a case where the terminal is the sensing signal receiving node, the method may further include: receiving the sensing signal measurement result. The sensing signal measurement result may include at least one of the following: the sensing signal identifier; the performance of the sensing signal; the time of arrival of the sensing signal; the angle of the sensing signal; the angle of the sensed target; the speed of the sensed target; or the distance from the sensed target. The performance of the sensing signal; the time of arrival of the sensing signal, the angle of the sensing signal, the angle of the sensed target, the speed of the sensed target, and the distance from the sensed target are individual measured quantities. Each measured quantity may include at least one of the following: the maximum value, the minimum value, or the granularity (i.e., the resolution).

In some embodiments, in a case where the terminal is the sensing signal receiving node, the access network device may further receive the sensing signal measurement result sent by the terminal.

For example, the terminal is determined as the sensing signal receiving node. The access network device may receive the sensing signal measurement result obtained from measurement of the terminal.

For example, the terminal may trigger sending, i.e., reporting, of the sensing signal measurement result based on some events. For example, the events may include: the signal strength of the sensing signal is greater than the signal strength threshold; the angle of the sensing signal is greater than or equal to the first angle threshold; the angle of the sensing signal is less than or equal to the second angle threshold; the delay of the sensing signal is less than the delay threshold; the distance from the sensed target is less than the distance threshold, and other possible situations. The sending of the sensing signal measurement result may also be triggered based on more possible events according to the actual case, which is not repeated in the present disclosure.

In some embodiments, the sensing signal measurement result may include the sensing signal identifier.

The identifier may be the ID or the index.

In some embodiments, the sensing signal measurement result may include the performance of the sensing signal.

For example, the performance may be the signal strength, the signal quality, etc.

In some embodiments, the sensing signal measurement result may include the time of arrival of the sensing signal.

In some embodiments, the sensing signal measurement result may include the angle of the sensing signal.

For example, the angle of the sensing signal may include at least one of the angle of arrival of the sensing signal or the angle of departure of the sensing signal.

In some embodiments, the sensing signal measurement result may include the angle of the sensed target.

For example, the angle of the sensed target includes at least one of the angle or the direction of the sensed target relative to the sensing node. For example, the sensed target is located 30 to 40 degrees southeast of the sensing node; the sensed target is located due north of the sensing node, etc.

In some embodiments, the sensing signal measurement result may include the speed of the sensed target.

For example, the speed of the sensed target includes at least one of the relative speed of the sensed target relative to the sensing node, or the absolute speed of the sensed target. For example, the relative speed of the sensed target relative to the sensing node is 0. The absolute speed of the sensed target is 10 m/s. It may represent that the sensed target and the sensing node move in the same direction and at the same speed.

In some embodiments, the sensing signal measurement result may include the distance from the sensed target.

In some embodiments, the sensing signal measurement result may further include the sensing signal identifier and the performance of the sensing signal; the time of arrival of the sensing signal, the angle of the sensing signal, the angle of the sensed target, the speed of the sensed target, and the distance from the sensed target; the sensing signal identifier, the performance of the sensing signal, the time of arrival of the sensing signal, the angle of the sensing signal, the angle of the sensed target, and the speed of the sensed target; or the sensing signal identifier, the performance of the sensing signal, the time of arrival of the sensing signal, the angle of the sensing signal, the angle of the sensed target, the speed of the sensed target, and the distance from the sensed target.

It may be understood that the sensing signal measurement result may also include any two, three, four, or five items, which are not enumerated in the present disclosure.

The terminal of the present disclosure may also report the sensing signal measurement result, and the plurality of possible parameters are provided, so that sensing may be performed by using the determined sensing node, thus improving the accuracy for sensing the sensed target.

In the communication sensing method provided by the embodiment of the present disclosure, the method may further include: transmitting a sensing request with at least one of the terminal, the other access network device or the sensing function entity. Transmitting the sensing request may include at least one of sending the sensing request or receiving the sensing request. The sensing request is configured to request sensing the sensed target.

In some embodiments, the access network device may transmit the sensing signal request with the terminal.

For example, the access network device may send the sensing request to the terminal. The access network device may also receive the sensing request sent by the terminal. The access network device may also both send the sensing request to the terminal and receive the sensing request sent by the terminal. The sensing request is configured to sense the sensed target.

In some embodiments, the access network device may transmit the sensing signal request with other access network device.

For example, the access network device may send the sensing request to the other access network device. The access network device may also receive the sensing request sent by the other access network device. The access network device may also both send the sensing request to the other access network device and receive the sensing request sent by the other access network device.

In some embodiments, the access network device may transmit the sensing signal request with the sensing function entity.

For example, the access network device may send the sensing request to the sensing function entity. The access network device may also receive the sensing request sent by the sensing function entity. The access network device may also both send the sensing request to the sensing function entity and receive the sensing request sent by the sensing function entity.

In some embodiments, the access network device may further transmit the sensing request with the terminal and the other access network device; transmit the sensing request with the terminal and the sensing function entity; transmit the sensing request with the other access network device and the sensing function entity; and transmit the sensing request with the terminal, the other access network device and the sensing function entity.

The present disclosure provides a plurality of methods for transmitting the sensing request, so that sensing may be performed by using the determined sensing node, thus improving the accuracy for sensing the sensed target.

In the communication sensing method provided by the embodiment of the present disclosure, the sensing request includes at least one of the service cell identifier or the tracking identifier of the terminal.

In some embodiments, the service cell identifier of the terminal may be included in the sensing request.

For example, the service cell ID of the terminal is included in the sensing request.

In some embodiments, the tracking identifier of the terminal may be included in the sensing request.

For example, the tracking ID of the terminal is included in the sensing request.

In some embodiments, the service cell identifier and the tracking identifier of the terminal may be included in the sensing request.

It may be understood that the sensing request includes the above information, which may be configured to determine the sensing node. For example, according to the above information, it may be determined that all terminals in a certain cell are sensing nodes, or that the access network device in a certain service cell is the sensing node, etc.

The present disclosure provides possible parameters included in the sensing request, which may be configured to determine the sensing node. As a result, sensing may be performed by using the determined sensing node, thus improving the accuracy for sensing the sensed target.

In the communication sensing method provided by the embodiment of the present disclosure, receiving the sensing request with the terminal based on at least one of the following: the random access procedure; the scheduling request; or the UL MAC CE.

In some embodiments, the access network device may receive the sensing request sent by the terminal based on the random access procedure.

For example, there is the association relationship between the sensing request and any possible random access resource. The random access resource includes any one or more of the random access time-domain resource, frequency-domain resource, and random access preamble. In a case where the terminal initiates random access based on the certain random access resource, it indicates to the access network device that the terminal sends the sensing request. Alternatively, the sensing request is carried in possible random access information, and the random access information carrying the sensing request is sent. For example, the sensing request is carried in the PUSCH of the Msg 3 or the Msg A during the random access procedure. A specific implementation process is not limited to the present disclosure.

In some embodiments, the access network device may receive the sensing request sent by the terminal based on the scheduling request.

For example, there is the association relationship between the sensing request and any possible scheduling request resource. The scheduling request resource includes any one or more of the scheduling request time-domain resource, frequency-domain resource, cyclic code, and information block. In a case where the terminal sends the scheduling request based on the certain scheduling request resource, it indicates to the access network device that the terminal sends the sensing request. A specific implementation process is not limited to the present disclosure.

In some embodiments, the access network device may receive the sensing request sent by the terminal based on the UL MAC CE.

For example, the access network device receives any possible UL MAC CE sent by the terminal. The sensing request is carried in the UL MAC CE. The UL MAC CE may be the existing UL MAC CE, or the UL MAC CE specifically used to carry the sensing request. A specific implementation process is not limited to the present disclosure.

The present disclosure provides a plurality of methods for receiving the sensing request with the terminal, and sensing is performed by using the determined sensing node, thus improving the accuracy for sensing the sensed target.

In the communication sensing method provided by the embodiment of the present disclosure, sending the sensing request with the terminal based on at least one of the following: the first DL MAC CE; the paging signal; or the first downlink control information.

In some embodiments, the access network device may send the sensing request to the terminal based on the first DL MAC CE.

For example, the access network device may send the sensing request along with the first DL MAC CE to the terminal. For example, the sensing request is carried in the first DL MAC CE. The first DL MAC CE may be any possible DL MAC CE, which is not limited to the present disclosure. The first DL MAC CE may be the existing DL MAC CE, or the DL MAC CE specifically used to carry the sensing request. A specific implementation process is not limited to the present disclosure.

In some embodiments, the access network device may send the sensing request to the terminal based on the paging signal.

For example, the access network device may send the sensing request along with the paging signal to the terminal. For example, the sensing request is carried in the paging signal. A specific implementation process is not limited to the present disclosure.

In some embodiments, the terminal may send the sensing request to the access network device based on the first DCI.

For example, the access network device may send the sensing request along with the first DCI to the terminal. For example, the sensing request is carried in the first DCI. The first DCI may be any possible DCI, which is not limited to the present disclosure. The first DCI may be the existing DCI, or the DCI specifically used to carry the sensing request. A specific implementation process is not limited to the present disclosure.

The present disclosure provides a plurality of methods for sending the sensing request with the access network device, and sensing is performed by using the determined sensing node, thus improving the accuracy for sensing the sensed target.

In the communication sensing method provided by the embodiment of the present disclosure, in a case where the sensing node is the terminal, the method may further include: sending indication information. The indication information is configured to indicate that the terminal is the sensing node.

In some embodiments, in a case where the sensing node is the terminal, the access network device may send the indication information to the terminal. The indication information is configured to indicate that the terminal is the sensing node.

The present disclosure may determine the sensing node via the indication information to be applicable to more scenarios. Furthermore, sensing is performed by using the determined sensing node, thus improving the accuracy for sensing the sensed target.

In the communication sensing method provided by the embodiment of the present disclosure, the indication information may include the cell identifier.

In some embodiments, the cell identifier may be included in the indication information.

For example, the access network device sends the indication information to the terminal. The cell identifier is included in the indication information. The terminal may determine whether the cell where it is located is the cell indicated by the cell identifier. Thus, it is possible to determine that the terminal is the sensing node in a case where the cell where the terminal is located is the cell indicated by the cell identifier.

According to the present disclosure, it is possible to indicate that the terminal is the sensing node via the cell identifier, so that sensing is performed by using the determined sensing node, thus improving the accuracy for sensing the sensed target.

In the communication sensing method provided by the embodiment of the present disclosure, the indication information includes at least one of the following: the first broadcast information, where the first broadcast information includes: the broadcast information carried on the PBCH, or the other system information carried on the PDSCH; the second DL MAC CE; or the second downlink control information.

In some embodiments, the indication information may include the first broadcast information. The first broadcast information may include the broadcast information carried on the PBCH or other system information carried on the PDSCH.

It may be understood that the indication information may be sent in the broadcast form to indicate that the corresponding device is the sensing node.

In some embodiments, the indication information may include the second DL MAC CE.

It may be understood that the second DL MAC CE may be sent in the unicast form to the designated device to indicate that the device is the sensing node. It may be understood that the second DL MAC CE and the first DL MAC CE may be the same DL MAC CE or different DL MAC CEs, which is not limited to the present disclosure.

In some embodiments, the indication information may include the second DCI.

It may be understood that the second DCI may be sent in the unicast form to the designated device to indicate that the device is the sensing node. It may be understood that the second DCI and the first DCI may be the same DCI or different DCIs, which is not limited to the present disclosure.

For example, the second DCI may be sent to a single user or to a plurality of users within one group. The paging and other downlink control information may be included in the second DCI. The paging in the embodiment may be the same as the paging for sending the sensing request or may be different, which is not limited to the present disclosure.

The second DCI may be DCI format 0_0/0_1/0_2 for scheduling the PUSCH, or DCI format 1_0/1_1/1_2 for scheduling the PDSCH. The second DCI may further be the group-based DCI format 2_0~2_7. The second DCI may further be DCI format 3_0/3_1 for the sidelink, or the new DCI format.

In some embodiments, the indication information may further include the first broadcast information and the second DL MAC CE; the first broadcast information and the second downlink control information; or the first broadcast information, the second DL MAC CE, and the second downlink control information.

The indication information of the present disclosure may include various information to support indicating the sensing node in various forms. As a result, sensing may be performed by using the determined sensing node, thus improving the accuracy for sensing the sensed target.

In the communication sensing method provided by the embodiment of the present disclosure, the first broadcast information is the broadcast information corresponding to the at least one SSB identifier.

In some embodiments, the first broadcast information may be broadcast information corresponding to the at least one SSB identifier.

For example, the SSB identifier may be the SSB ID.

The first broadcast information may be broadcast information corresponding to each SSB identifier. In other words, the broadcast information corresponding to each SSB identifier includes the above indication information. Then the terminal within the beam coverage range corresponding to each SSB identifier may receive the indication information. While the first broadcast information may also be broadcast information corresponding to one or more designated SSB identifiers. In other words, the above indication information is included in the broadcast information corresponding to the one or more designated SSB identifiers. Then only the terminal within the beam coverage range corresponding to the one or more designated SSB identifiers may receive the indication information.

The present disclosure provides the form of expression of the first broadcast information to indicate the sensing node. As a result, sensing may be performed by using the determined sensing node, thus improving the accuracy for sensing the sensed target.

In the communication sensing method provided by the embodiment of the present disclosure, FIG. 5 is a flowchart of a communication sensing method according to yet another example. As shown in FIG. 5, in a case where the sensing node is the access network device, determining the sensing node in S31 may further include the following steps.

In step S41, the sensing signal or the reference signal is received.

In some embodiments, the access network device may receive the sensing signal sent by the terminal.

For example, the reference signal may be the SSB, the CSI-RS, the DMRS, etc. The reference signal may also be the reference signal specifically used to determine the sensing node. It may be understood that the present disclosure does not limit a specific form of the reference signal.

For example, the resource configuration of the sensing signal or the reference signal may be indicated by the sensing function entity. Alternatively, the resource configuration of the sensing signal or the reference signal may be broadcast by the access network device. Afterwards, the terminal may send the sensing signal or the reference signal on the corresponding resource based on the resource configuration of the sensing signal or the reference signal. For example, the sensing signal or the reference signal may be sent via the omni-directional broadcast, or broadcast based on the specific beam.

In step S42, the performance of the sensing signal or the performance of the reference signal is determined.

In some embodiments, the access network device may determine the performance of the sensing signal or the performance of the reference signal by measuring the sensing signal or the reference signal.

For example, the performance may be the signal quality, the signal strength, etc.

In step S43, it is determined that the access network device is the sensing node based on the performance of the sensing signal or the performance of the reference signal meeting the performance condition.

In some embodiments, the access network device may determine whether the performance of the sensing signal meets the performance condition, or determine whether the performance of the reference signal meets the performance condition. The access network device determines that the access network device is the sensing node based on the performance of the sensing signal or the performance of the reference signal meeting the performance condition.

For example, in a case where the access network device receives the sensing signal, the access network device may determine that itself is the sensing node based on the performance of the sensing signal meeting the performance condition. For another example, in a case where the access network device receives the reference signal, the access network device may determine that itself is the sensing node based on the performance of the reference signal meeting the performance condition.

The performance condition may be, for example, some preset thresholds.

In some embodiments, if the access network device receives the sensing signal, it may directly determine that itself is the sensing node based on the feature of the sensing signal meeting the corresponding condition.

For example, the access network device receives the sensing signal. The features such as the signal strength and the signal quality of the sensing signal meet the preset corresponding conditions, for example, the signal strength of the sensing signal is greater than the certain preset signal strength threshold, and the signal quality is greater than or equal to the certain preset signal quality threshold, etc. Thus, the access network device may directly determine that itself is the sensing node.

According to the present disclosure, the sensing node suitable for transmitting the sensing signal is determined based on the performance situation of the sensing signal or the reference signal, so that sensing is performed by using the determined sensing node, thus improving the accuracy for sensing the sensed target.

In the communication sensing method provided by the embodiment of the present disclosure, the performance condition is determined based on at least one of the following: configuration information received from the sensing function entity, or the default rule.

In some embodiments, the access network device may receive the configuration information from the sensing function entity to determine the performance condition.

For example, the access network device receives the configuration information sent by the sensing function entity, e.g., sent in the broadcast form, and determines at least one of the performance of the sensing signal or the performance of the reference signal.

In some embodiments, the access network device may determine the performance condition based on the default rule.

For example, the default rule may be the rule that is pre-specified in the protocol, or pre-configured, etc.

In some embodiments, the access network device may receive the configuration information from the sensing function entity to determine the performance condition, and the access network device may determine the performance condition based on the default rule.

The present disclosure provides the plurality of methods for determining the performance condition, so that the terminal determines the sensing node suitable for transmitting the sensing signal according to the performance condition. As a result, sensing may be performed by using the determined sensing node, thus improving the accuracy for sensing the sensed target.

In the communication sensing method provided by the embodiment of the present disclosure, the sensing node includes at least one of the sensing signal sending node or the sensing signal receiving node. The access network device is at least one of the sensing signal sending node or the sensing signal receiving node.

In some embodiments, the sensing node may include the sensing signal sending node. The terminal may be the sensing signal sending node.

It may be understood that the sensing signal sending node is the node configured to send the sensing signal.

In some embodiments, the sensing node may include the sensing signal receiving node. The access network device may be the sensing signal receiving node.

It may be understood that the sensing signal sending node is the node configured to send the sensing signal.

In some embodiments, the sensing node may include the sensing signal sending node and the sensing signal receiving node. The access network device may be the sensing signal sending node and the sensing signal receiving node.

The access network device of the present disclosure may be at least one of the sensing signal sending node or the sensing signal receiving node. As a result, sensing may be performed by using the determined sensing node, thus improving the accuracy for sensing the sensed target.

In the communication sensing method provided by the embodiment of the present disclosure, the performance of the sensing signal is the signal strength or signal quality of the sensing signal. The performance of the reference signal is the signal strength or signal quality of the reference signal.

In some embodiments, the performance of the sensing signal may be the signal strength of the sensing signal.

In some embodiments, the performance of the sensing signal may be the signal quality of the sensing signal.

For example, the signal strength may be at least one of the L1-RSRP or the L3-RSRP.

For another example, the signal quality may be at least one of the L1-SINR, the L3-SINR, or the L3-RSRQ.

The present disclosure provides the plurality of possible parameters of the performance of the sensing signal, so that sensing may be performed by using the determined sensing node, thus improving the accuracy for sensing the sensed target.

In the communication sensing method provided by the embodiment of the present disclosure, the sensing node includes at least one of the sensing signal sending node or the sensing signal receiving node. Determining the sensing node includes at least one of the following: determining that the access network device is the sensing signal sending node based on the sensing function entity, in a case where the sensing initiating node is the sensing function entity; determining that the access network device is the sensing signal sending node and the sensing signal receiving node based on the sensing function entity, in a case where the sensing initiating node is the sensing function entity; determining that the access network device is the sensing signal receiving node based on at least one of the sensing function entity or other access network device, in a case where the sensing initiating node is the sensing function entity, where the other access network device is the sensing signal sending node; determining that the access network device is the sensing signal sending node and the sensing signal receiving node based on at least one of the sensing function entity or the access network device, in a case where the sensing initiating node is the access network device; determining that the access network device is the sensing signal sending node based on at least one of the sensing function entity or the access network device, in a case where the sensing initiating node is the access network device; determining that the access network device is the sensing signal receiving node based on at least one of the sensing function entity or the access network device, in a case where the sensing initiating node is the access network device; or determining that the access network device is the sensing signal receiving node based on at least one of the sensing function entity or the other access network device, in a case where the sensing initiating node is other access network device.

In some embodiments, the sensing node may include at least one of the sensing signal sending node or the sensing signal receiving node.

In some embodiments, it is determined that the access network device is the sensing signal sending node based on the sensing function entity in a case where the sensing initiating node is the sensing function entity.

For example, it may be determined that the access network device is the sensing signal sending node based on the sensing function entity in a case where the sensing initiating node is the sensing function entity.

In some embodiments, it is determined that the access network device is the sensing signal receiving node based on at least one of the sensing function entity or the other access network device, in a case where the sensing initiating node is the sensing function entity. The other access network device is the sensing signal sending node.

For example, it may be determined that the access network device is the sensing signal sending node based on the sensing function entity in a case where the sensing initiating node is the sensing function entity.

For another example, it may be determined that the access network device is the sensing signal sending node based on the other access network device in a case where the sensing initiating node is the sensing function entity. The other access network device is the sensing signal sending node.

In some embodiments, it is determined that the access network device is the sensing signal sending node, and the sensing signal receiving node is based on the sensing function entity, in a case where the sensing initiating node is the sensing function entity.

For example, it may be determined that the access network device is the sensing signal sending node and the sensing signal receiving node based on the sensing function entity in a case where the sensing initiating node is the sensing function entity.

In some embodiments, it is determined that the access network device is the sensing signal sending node and the sensing signal receiving node based on at least one of the sensing function entity or the access network device in a case where the sensing initiating node is the access network device.

For example, it may be determined that the access network device is the sensing signal sending node and the sensing signal receiving node based on the sensing function entity in a case where the sensing initiating node is the access network device.

For another example, it may be determined that the access network device is the sensing signal sending node and the sensing signal receiving node based on the other access network device in a case where the sensing initiating node is the access network device.

In some embodiments, it is determined that the access network device is the sensing signal sending node based on at least one of the sensing function entities or the access network device, in a case where the sensing initiating node is the access network device.

For example, it may be determined that the access network device is the sensing signal sending node based on the sensing function entity in a case where the sensing initiating node is the access network device.

For another example, it may be determined that the access network device is the sensing signal sending node based on the access network device in a case where the sensing initiating node is the access network device.

In some embodiments, it is determined that the access network device is the sensing signal receiving node based on at least one of the sensing function entity or the access network device in a case where the sensing initiating node is the access network device.

For example, it may be determined that the access network device is the sensing signal receiving node based on the sensing function entity in a case where the sensing initiating node is the access network device.

For another example, it may be determined that the access network device is the sensing signal receiving node based on the access network device in a case where the sensing initiating node is the access network device.

In some embodiments, it is determined that the access network device is the sensing signal receiving node based on at least one of the sensing function entity or the other access network device in a case where the sensing initiating node is the other access network device.

For example, it may be determined that the access network device is the sensing signal receiving node based on the sensing function entity in a case where the sensing initiating node is the other access network device.

For another example, it may be determined that the access network device is the sensing signal receiving node based on the other access network device in a case where the sensing initiating node is the other access network device.

In some embodiments, determining the sensing node may further include: determining that the access network device is the sensing signal sending node based on the sensing function entity, in a case where the sensing initiating node is the sensing function entity; determining that the access network device is the sensing signal sending node and the sensing signal receiving node based on the sensing function entity, in a case where the sensing initiating node is the sensing function entity; determining that the access network device is the sensing signal receiving node based on at least one of the sensing function entity or the other access network device, in a case where the sensing initiating node is the sensing function entity; determining that the access network device is the sensing signal sending node and the sensing signal receiving node based on at least one of the sensing function entity or the access network device, in a case where the sensing initiating node is the access network device; determining that the access network device is the sensing signal sending node based on at least one of the sensing function entity or the access network device, in a case where the sensing initiating node is the access network device; determining that the access network device is the sensing signal receiving node based on at least one of the sensing function entity or the access network device, in a case where the sensing initiating node is the access network device; determining that the access network device is the sensing signal receiving node based on at least one of the sensing function entity or the other access network device, in a case where the sensing initiating node is the other access network device; determining that the access network device is the sensing signal sending node based on the sensing function entity, in a case where the sensing initiating node is the sensing function entity; determining that the access network device is the sensing signal sending node and the sensing signal receiving node based on the sensing function entity, in a case where the sensing initiating node is the sensing function entity; determining that the access network device is the sensing signal sending node based on the sensing function entity, in a case where the sensing initiating node is the sensing function entity; determining that the access network device is the sensing signal sending node and the sensing signal receiving node based on the sensing function entity, in a case where the sensing initiating node is the sensing function entity; determining that the access network device is the sensing signal receiving node based on at least one of the sensing function entity or the other access network device, in a case where the sensing initiating node is the sensing function entity; determining that the access network device is the sensing signal sending node and the sensing signal receiving node based on at least one of the sensing function entity or the access network device, in a case where the sensing initiating node is the access network device; determining that the access network device is the sensing signal sending node based on at least one of the sensing function entity or the access network device, in a case where the sensing initiating node is the access network device; determining that the access network device is the sensing signal sending node based on the sensing function entity, in a case where the sensing initiating node is the sensing function entity; determining that the access network device is the sensing signal sending node and the sensing signal receiving node based on the sensing function entity, in a case where the sensing initiating node is the sensing function entity; determining that the access network device is the sensing signal receiving node based on at least one of the sensing function entity or the other access network device, in a case where the sensing initiating node is the sensing function entity; determining that the access network device is the sensing signal sending node and the sensing signal receiving node based on at least one of the sensing function entity or the access network device, in a case where the sensing initiating node is the access network device; determining that the access network device is the sensing signal sending node based on at least one of the sensing function entity or the access network device, in a case where the sensing initiating node is the access network device; determining that the access network device is the sensing signal receiving node based on at least one of the sensing function entity or the access network device, in a case where the sensing initiating node is the access network device; determining that the access network device is the sensing signal sending node based on the sensing function entity, in a case where the sensing initiating node is the sensing function entity; determining that the access network device is the sensing signal sending node and the sensing signal receiving node based on the sensing function entity, in a case where the sensing initiating node is the sensing function entity; determining that the access network device is the sensing signal receiving node based on at least one of the sensing function entity or the other access network device, in a case where the sensing initiating node is the sensing function entity; determining that the access network device is the sensing signal sending node and the sensing signal receiving node based on at least one of the sensing function entity or the access network device, in a case where the sensing initiating node is the access network device; determining that the access network device is the sensing signal sending node based on at least one of the sensing function entity or the access network device, in a case where the sensing initiating node is the access network device; determining that the access network device is the sensing signal sending node based on the sensing function entity, in a case where the sensing initiating node is the sensing function entity; determining that the access network device is the sensing signal sending node and the sensing signal receiving node based on the sensing function entity, in a case where the sensing initiating node is the sensing function entity; determining that the access network device is the sensing signal receiving node based on at least one of the sensing function entity or the other access network device, in a case where the sensing initiating node is the sensing function entity; determining that the access network device is the sensing signal sending node and the sensing signal receiving node based on at least one of the sensing function entity or the access network device, in a case where the sensing initiating node is the access network device; determining that the access network device is the sensing signal sending node based on at least one of the sensing function entity or the access network device, in a case where the sensing initiating node is the access network device; determining that the access network device is the sensing signal receiving node based on at least one of the sensing function entity or the access network device, in a case where the sensing initiating node is the access network device; and determining that the access network device is the sensing signal receiving node based on at least one of the sensing function entity or the other access network device, in a case where the sensing initiating node is other access network device.

It may be understood that a method for determining the sensing node may also include any two, three, four, five, six, or seven items of the above, which are not enumerated in the present disclosure.

The present disclosure provides a plurality of methods for determining the sensing node, so that sensing may be performed by using the determined sensing node, thus improving the accuracy for sensing the sensed target.

In the communication sensing method provided by the embodiment of the present disclosure, it is determined that the access network device is the sensing signal sending node based on at least one of the sensing function entity or the access network device in a case where the sensing initiating node is the access network device. The method may further include: determining that the other access network device is the sensing signal receiving node.

In some embodiments, it is determined that the access network device is the sensing signal sending node based on at least one of the sensing function entity or the access network device in a case where the sensing initiating node is the access network device. Then, the access network device may also determine that the other access network device is the sensing signal receiving node.

The present disclosure provides a plurality of methods for determining the sensing node, so that sensing may be performed by using the determined sensing node, thus improving the accuracy for sensing the sensed target.

In the communication sensing method provided by the embodiment of the present disclosure, in a case where the sensing initiating node is the terminal, determining the sensing node in S31 may include: determining that the access network device is the sensing node based on the serving cell of the terminal.

In some embodiments, in a case where the sensing initiating node is the terminal, the access network device may determine that itself is the sensing node based on the service cell of the terminal.

For example, the access network device is an access network device for the service cell of the terminal.

The present disclosure provides a plurality of methods for determining the sensing node, so that sensing may be performed by using the determined sensing node, thus improving the accuracy for sensing the sensed target.

In the communication sensing method provided by the embodiment of the present disclosure, a sensing mode for performing sensing includes at least one of the following: determining the access network device as the sensing signal sending node, and determining the terminal as the sensing signal receiving node; determining the access network device as the sensing signal receiving node, and determining the terminal as the sensing signal sending node; determining the access network device as the sensing signal sending node and the sensing signal receiving node; determining a first access network device as the sensing signal sending node, and determining a second access network device as the sensing signal receiving node, where the access network device is the first access network device or the second access network device; determining the access network device as the sensing signal sending node and the sensing signal receiving node; determining a first terminal as the sensing signal sending node, and determining the second terminal as the sensing signal receiving node, where the terminal is the first terminal or the second terminal; or determining the terminal as the sensing signal sending node and the sensing signal receiving node.

In some embodiments, the sensing mode for performing sensing may include determining the access network device as the sensing signal sending node, and determining the terminal as the sensing signal receiving node.

For example, the sensing mode may be sensing mode 6.

In some embodiments, the sensing mode for performing sensing may include determining the access network device as the sensing signal receiving node, and determining the terminal as the sensing signal sending node.

For example, the sensing mode may be sensing mode 5.

In some embodiments, the sensing mode for performing sensing may include determining the first access network device as the sensing signal sending node, and determining the second access network device as the sensing signal receiving node, where the access network device is the first access network device or the second access network device.

For example, the sensing mode may be sensing mode 2. It may be understood that the first access network device and the second access network device may be different access network devices.

In some embodiments, the sensing mode for performing sensing may include determining the access network device as the sensing signal sending node and the sensing signal receiving node.

For example, the sensing mode may be sensing mode 1.

In some embodiments, the sensing mode for performing sensing may include determining the terminal as the sensing signal sending node and the sensing signal receiving node.

For example, the sensing mode may be sensing mode 3.

In some embodiments, the sensing mode for performing sensing may include determining the first terminal as the sensing signal sending node, and determining the second terminal as the sensing signal receiving node, where the terminal is the first terminal or the second terminal.

For example, the sensing mode may be sensing mode 4. It may be understood that the first terminal and the second terminal may be different terminals.

The present disclosure is applicable to the plurality of different sensing mode scenarios to determine sensing nodes in the corresponding scenarios, so that sensing is performed by using the determined sensing node, thus improving the accuracy for sensing the sensed target.

In some implementations, the present disclosure describes how to determine each sensing node from the perspective of the sensing node.

In some implementations, the terminal may be determined as the sensing node.

In some embodiments, the sensing mode is between the access network device and the terminal. Since merely an approximate position of the sensed target can be known, it is not possible to accurately determine the terminal used as the sensing node. In this case, then, a plurality of terminals may be determined as sensing nodes.

For a case where the terminal is the sensing signal receiving node:

the sensing function entity may indicate a resource configuration of the sensing signal (which may also be other reference signal, e.g. the SSB, the CSI-RS, or the reference signal specifically used to determine the sensing node). Alternatively, the access network device broadcasts the resource configuration of the sensing signal. The access network device may broadcast the sensing signal (which may also be other reference signal) omni-directionally or based on a beam.

The terminal as the sensing node is determined based on the performance of the received sensing signal (which may also be other reference signal), and the terminal is configured to perform reporting of the sensing result based on event triggering. For example, reporting based on the event triggering may be: the strength of the sensing signal is greater than a threshold, the angle of the sensing signal is less than a threshold; a delay of the sensing signal is less than a threshold; the distance from the sensed target is less than a threshold, etc. A reported result may include at least one of the sensing signal ID, the strength of the sensing signal, the time of arrival of the sensing signal, the angle of the sensing signal, or the distance from the sensed target, etc.

Here, if the terminal is determined as the sensing signal receiving node, a special case is that the access network device directly sends the sensing signal, then other UE finds that the feature of a received sensing signal meets the condition, and thus the other UE may directly determine itself as the sensing node and report the sensing result. It may be understood that the terminal may be determined as at least one of the sensing signal sending node or the sensing signal receiving node.

The threshold mentioned above may be broadcast by the access network device or configured by the sensing function entity.

For a case where the terminal is the sensing signal sending node: the L1-RSRP or the L3-RSRP of at least one of the SSB or the CSI-RS may be used. Alternatively, the L1-SINR, L3-SINR, or L3-RSRQ of at least one of the SSB or the CSI-RS may be used. Similarly, the terminal that may be used as the sensing node may be determined by sending based on the omni-direction or based on the beam. The method is similar to the method for determining that the terminal is the sensing signal receiving node. The access network device or the sensing function entity sends the resource configuration of the reference signal for determining the sensing node, which may be, for example, the SSB or the CSI-RS as referred to here, and may also be the sensing signal or the reference signal specifically used to determine the sensing node. The access network device sends the reference signal. The terminal compares the L1-RSRP, L3-RSRP, L1-SINR, L3-SINR or L3-RSRQ of the reference signal with a threshold. If it is greater than the threshold, the terminal may be determined as at least one of the sensing nodes for sending the sensing signal, or the sensing node for receiving the sensing signal.

In some cases, such as where the reference signal configured to determine the sensing node is not the same as the sensing signal, the access network device or the sensing function entity is further required to further indicate the resource configuration of the sensing signal.

The method for configuring the threshold mentioned above includes configuring by the sensing function entity or the gNB, or configuring based on the default value.

Regardless of whether the terminal is determined as the sensing signal sending node or the sensing signal receiving node, if the sensing initiating node is a certain terminal, then the terminal is required to send the sensing request to the access network device or the sensing function entity. At least one of the service cell ID or the tracking ID of the terminal is included in the sensing request.

The terminal sends the corresponding service cell ID, i.e., it may inform the access network device or the sensing function entity that it may be determined that all terminals within the cell are sensing nodes. A method for the tracking ID is similar, which is not repeated here.

It may be understood that the sensing function entity is a core network device that manages a sensing task.

In some embodiments, in a case where the sensing mode is the terminal, if the sensing function entity is the sensing initiating node, it is determined one of the following: which cell coverage range in which the terminal is the sensing node, which beam coverage range in which the terminal is the sensing node, which range of the L1-RSRP or the L3-RSRP of at least one of the SSB or the CSI-RS in which the terminal is the sensing node, or which range of the L1-SINR, the L3-SINR or the L3-RSRQ of at least one of the SSB or the CSI-RS in which the terminal is the sensing node.

These thresholds may be broadcast by the base station or configured by the sensing function entity.

If the terminal is the sensing initiating node, then the terminal may be determined as the sensing node.

If the terminal is determined as the sensing initiating node, it may send the reference signal to determine the sensing node. The reference signal may include at least one of: the sensing signal, the sidelink SSB, the sidelink CSI-RS, or the reference signal specifically used to determine the sensing node. For example, the reference signal is broadcast based on the omni-direction or based on the beam. Then, based on the performance of the received reference signal, it is determined whether the other terminal is the sensing node.

If the sensing node for receiving the sensing signal is determined, the reference signal may be directly the sensing signal, and the terminal is configured to perform reporting of the sensing result based on the event triggering. For example, reporting is performed in cases where the strength of the sensing signal is greater than the threshold, the angle of the sensing signal is less than the threshold, the delay of the sensing signal is less than the threshold, and the distance from the sensed target is less than the threshold. A reported result may include at least one of the sensing signal ID, the strength of the sensing signal, the time of arrival of the sensing signal, the angle of the sensing signal, the distance from the sensed target, etc.

If the sensing node for sending the sensing signal is determined or the sensing node for sending and receiving the sensing signal is determined, then the reference signal may be at least one of the sensing signal, the SSB, the CSI-RS, or the reference signal specifically used to determine the sensing node. In addition, based on the L1-RSRP, L3-RSRP, L1-SINR, L3-SINR or L3-RSRQ of the reference signal, the sensing node is determined, and a sensing signal resource for determining the sensing node and a sensing signal resource to be sent by the sensing node behind may be independently configured or generically configured, e.g., configured by the base station or the sensing function entity.

In some implementations, the access network device may be determined as the sensing node.

In some embodiments, in a case where the sensing mode is between the access network device and the terminal, if the sensing function entity is the sensing initiating node, a first access network device is first determined by the sensing function entity. If the first access network device may perform the self-sending and self-receiving, a second access network device is not required. Otherwise, the second access network device is determined by the sensing functional entity or the first access network device, and the first access network device or the sensing function entity is informed.

If the access network device is the sensing initiating node, at least one of the access network devices or the sensing function entity determines that the first access network device is the sensing node.

If it is determined that the access network device may perform self-sending and self-receiving, there is no need to determine the other access network device.

If it is determined that the access network device is the first access network device, then the second access network device is determined by at least one of the sensing function entity or the first access network device, and the first access network device or the sensing function entity is informed. For example, it may be determined based on a capability of the access network device or whether the access network device is idle.

If it is determined that the access network device is the second access network device, then the first access network device is determined by at least one of the sensing function entity or the second access network device, and the second access network device or the sensing function entity is informed.

In some embodiments, in a case where the sensing mode is the access network device, if the sensing function entity or the access network device is the sensing initiating node, similar to the above case where the sensing mode is between the access network device and the terminal, it is not repeated here.

If the terminal is the sensing initiating node, the access network device where the service cell of the terminal is located is determined as the sensing node. If the access network device initiates the sensing request to the sensing function entity, the terminal may report that the sensing function entity sends the service cell identifier. For example, it may be an idle and inactive terminal.

It may be understood that communication between at least one of the terminal or the access network device and the sensing function entity in the above embodiments may be signaling specialized for communication with the sensing function entity.

According to the present disclosure, the sensing node suitable for transmitting the sensing signal is determined, so that sensing is performed by using the determined sensing node, thus improving accuracy for sensing the sensed target.

It needs to be noted that those skilled in the art may understand that the various implementations or embodiments involved above in the embodiments of the present disclosure may be used in conjunction with the foregoing embodiments or may be used independently. Whether they are used alone or in conjunction with the foregoing embodiments, their implementation principles are similar. In the implementation of the present disclosure, some embodiments are illustrated with implementations used together. Those skilled in the art may understand that such an illustrative description is not a limitation of the embodiments of the present disclosure.

Based on the same concept, an embodiment of the present disclosure further provides a communication sensing apparatus and device.

It may be understood that, in order to implement the above functions, the communication sensing apparatus and device provided by the embodiment of the present disclosure include at least one of a hardware structure or a software module for performing each function. In combination with units and algorithm steps of each instance disclosed in the embodiment of the present disclosure, the embodiment of the present disclosure may be implemented in the form of hardware or a combination of hardware and computer software. Whether a certain function is performed by hardware or computer software driving hardware depends on the specific application and design constraints of the technical solutions. Those skilled in the art can use different methods to implement the described functions for each specific application, but such implementation should not be considered to be beyond the scope of the technical solutions of the embodiment of the present disclosure.

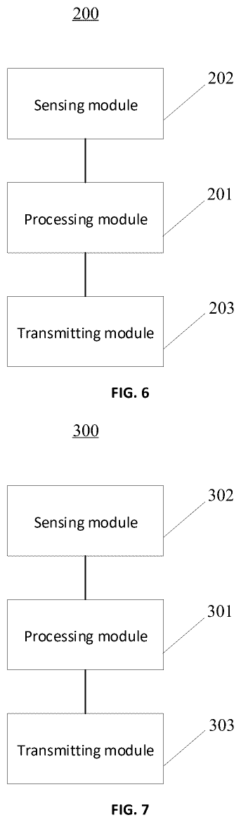

FIG. 6 is a schematic diagram of a communication sensing apparatus according to an example. Referring to FIG. 6, the apparatus 200 is configured in a terminal. The apparatus 200 includes: a processing module 201, configured to determine the sensing node; and a sensing module 202, configured to transmit the sensing signal by using the sensing node. The sensing signal is configured to sense the sensed target.

According to the present disclosure, the sensing node suitable for transmitting the sensing signal is determined, so that sensing is performed by using the determined sensing node, thus improving accuracy for sensing the sensed target.

In some implementations, the apparatus 200 further includes: a transmitting module 203. In a case where the sensing node is the terminal, the transmitting module 203 is further configured to: receive the sensing signal or the reference signal sent by the access network device or the other terminal. The processing module 201 is further configured to determine the performance of the sensing signal or the performance of the reference signal. The processing module 201 is further configured to determine the sensing node based on the performance of the sensing signal or the performance of the reference signal meeting the performance condition.

According to the present disclosure, the sensing node suitable for transmitting the sensing signal is determined via the performance situation of the sensing signal or the reference signal, so that sensing is performed by using the determined sensing node, thus improving the accuracy for sensing the sensed target.

In some implementations, the performance condition is determined based on at least one of the following: the configuration information received from the sensing function entity; the configuration information received from the access network device; or the default rule.

The present disclosure provides the plurality of methods for determining the performance condition, so that the terminal determines the sensing node suitable for transmitting the sensing signal according to the performance condition. As a result, sensing may be performed by using the determined sensing node, thus improving the accuracy for sensing the sensed target.

In some implementations, the sensing node includes at least one of the sensing signal sending node or the sensing signal receiving node. The terminal is at least one of the sensing signal sending node or the sensing signal receiving node.

The terminal of the present disclosure may be at least one of the sensing signal sending node or the sensing signal receiving node. As a result, sensing may be performed by using the determined sensing node, thus improving the accuracy for sensing the sensed target.

In some implementations, in a case where the terminal is the sensing signal receiving node, the transmitting module 203 is further configured to send the sensing signal measurement result. The sensing signal measurement result includes at least one of the following: the sensing signal identifier; the performance of the sensing signal; the time of arrival of the sensing signal; the angle of the sensing signal; the angle of the sensed target; the speed of the sensed target; or the distance from the sensed target.

The terminal of the present disclosure may also report the sensing signal measurement result, and the plurality of possible parameters are provided, so that sensing may be performed by using the determined sensing node, thus improving the accuracy for sensing the sensed target.

In some implementations, the performance of the sensing signal is the signal strength or the signal quality of the sensing signal. The performance of the reference signal is the signal strength or the signal quality of the reference signal.

The present disclosure provides the plurality of possible parameters of the performance of the sensing signal, so that sensing may be performed by using the determined sensing node, thus improving the accuracy for sensing the sensed target.

In some implementations, the transmitting module 203 is further configured to: transmit the sensing request with at least one of the other terminal, the access network device or the sensing function entity. Transmitting the sensing request includes at least one of sending the sensing request or receiving the sensing request. The sensing request is configured to request sensing the sensing target.

The present disclosure provides the plurality of methods for transmitting the sensing request, so that sensing may be performed by using the determined sensing node, thus improving the accuracy for sensing the sensed target.

In some implementations, the sensing request includes at least one of the service cell identifier or the tracking identifier of the terminal.

The present disclosure provides possible parameters included in the sensing request, which may be configured to determine the sensing node. As a result, sensing may be performed by using the determined sensing node, thus improving the accuracy for sensing the sensed target.

In some implementations, sending the sensing request with the access network device based on at least one of the following: the random access procedure, the scheduling request, or the UL MAC CE.

The present disclosure provides the plurality of methods for sending the sensing request with the access network device, and sensing is performed by using the determined sensing node, thus improving the accuracy for sensing the sensed target.

In some implementations, receiving the sensing request with the access network device based on at least one of the following: the first DL MAC CE; the paging signal; or the first downlink control information.

The present disclosure provides the plurality of methods for receiving the sensing request with the access network device, and sensing is performed by using the determined sensing node, thus improving the accuracy for sensing the sensed target.

In some implementations, transmitting the sensing request with the other terminal based on at least one of the following: the sidelink broadcast channel; the first sidelink MAC CE; or the first sidelink control information.

The present disclosure provides the plurality of methods for transmitting the sensing request with the other terminal, and sensing is performed by using the determined sensing node, thus improving the accuracy for sensing the sensed target.

In some implementations, in a case where the sensing node is the terminal, the transmitting module 203 is further configured to: receive the indication information sent by the access network device, the other terminal, or the sensing function entity. The indication information is configured to indicate that the terminal is the sensing node.

The present disclosure may determine the sensing node via the indication information to be applicable to more scenarios. And sensing is performed by using the determined sensing node, thus improving the accuracy for sensing the sensed target.

In some implementations, in a case where the indication information sent by the access network device or the sensing function entity is received, the indication information includes the cell identifier.

According to the present disclosure, it is possible to indicate that the terminal is the sensing node via the cell identifier, so that sensing is performed by using the determined sensing node, thus improving the accuracy for sensing the sensed target.

In some implementations, in a case where the indication information sent by the access network device is received, the indication information includes at least one of the following: the first broadcast information, where the first broadcast information includes: the broadcast information carried on the PBCH, or the other system information carried on the PDSCH; the second DL MAC CE; or the second downlink control information.

The indication information of the present disclosure may include various information to support indicating the sensing node in various forms. As a result, sensing may be performed by using the determined sensing node, thus improving the accuracy for sensing the sensed target.

In some implementations, the first broadcast information is the broadcast information corresponding to the at least one SSB identifier.

The present disclosure provides the form of expression of the first broadcast information to indicate the sensing node. As a result, sensing may be performed by using the determined sensing node, thus improving the accuracy for sensing the sensed target.

In some implementations, in a case where the indication information sent by the other terminal is received, the indication information includes at least one of the following: the second broadcast information, where the second broadcast information includes: the broadcast information carried on the PBCH of the sidelink, or the other system information carried on the PSSCH of the sidelink; the second sidelink MAC CE; or the second sidelink control information.

The indication information of the present disclosure may include various information to support indicating the sensing node in various forms. As a result, sensing may be performed by using the determined sensing node, thus improving the accuracy for sensing the sensed target.

In some implementations, the second broadcast information is the broadcast information corresponding to the at least one sidelink SSB identifier.

The present disclosure provides the form of expression of the second broadcast information to indicate the sensing node. As a result, sensing may be performed by using the determined sensing node, thus improving the accuracy for sensing the sensed target.

In some implementations, the transmitting module 203 is further configured to: send the sensing signal or the reference signal. The sensing signal or the reference signal is configured to determine that the other terminal or the access network device is the sensing node.

The present disclosure provides a plurality of forms for determining the sensing node so that sensing may be performed using the determined sensing node, thus improving the accuracy of sensing the sensed target.

In some implementations, the sensing mode for performing sensing may include at least one of the following: determining the access network device as the sensing signal sending node, and determining the terminal as the sensing signal receiving node; determining the access network device as the sensing signal receiving node, and determining the terminal as the sensing signal sending node; determining the first terminal as the sensing signal sending node, and determining the second terminal as the sensing signal receiving node, where the terminal is the first terminal or the second terminal; or determining the terminal as the sensing signal sending node and the sensing signal receiving node.

The present disclosure is applicable to the plurality of different sensing mode scenarios to determine sensing nodes in the corresponding scenarios, so that sensing is performed by using the determined sensing node, thus improving the accuracy for sensing the sensed target.

FIG. 7 is a schematic diagram of a communication sensing apparatus according to another example. Referring to FIG. 7, the apparatus 300 is configured in an access network device. The apparatus 300 includes: a processing module 301, configured to determine the sensing node; and a sensing module 302, configured to transmit the sensing signal by using the sensing node. The sensing signal is configured to sense the sensed target.

According to the present disclosure, the sensing node suitable for transmitting the sensing signal is determined, so that sensing is performed by using the determined sensing node, thus improving accuracy for sensing the sensed target.

In some implementations, the sensing function entity or the access network device is the sensing initiating node, where the sensing initiating node is the node that sends the sensing request. The sensing request is configured to request sensing the sensed target.

The present disclosure provides the plurality of forms of expression of the sensing initiating node, the sensing request is sent, so that sensing is performed by using the determined sensing node, thus improving the accuracy for sensing the sensed target.

In some implementations, in a case where the sensing node is the terminal, the apparatus 300 further includes: a transmitting module 303, configured to send the sensing signal or the reference signal.

According to the present disclosure, the sensing node is determined by sending the sensing signal or the reference signal, so that sensing may be performed by using the determined sensing node, thus improving the accuracy for sensing the sensed target.

In some implementations, the transmitting module 303 is further configured to: send the configuration information. The configuration information is configured to configure the performance condition. The performance condition is configured for the terminal to determine that the terminal is the sensing node based on the performance of the sensing signal or the performance of the reference signal meeting the performance condition.

According to the present disclosure, the sensing node suitable for transmitting the sensing signal is determined via the performance situation of the sensing signal or the reference signal, so that sensing is performed by using the determined sensing node, thus improving the accuracy for sensing the sensed target.

In some implementations, the sensing node includes at least one of the sensing signal sending node or the sensing signal receiving node. The terminal is at least one of the sensing signal sending node or the sensing signal receiving node.

The terminal of the present disclosure may be at least one of the sensing signal sending node or the sensing signal receiving node. As a result, sensing may be performed by using the determined sensing node, thus improving the accuracy for sensing the sensed target.

In some implementations, in a case where the terminal is the sensing signal receiving node, the transmitting module 303 is further configured to: receive the sensing signal measurement result. The sensing signal measurement result includes at least one of the following: the sensing signal identifier; the performance of the sensing signal; the time of arrival of the sensing signal; the angle of the sensing signal; the angle of the sensed target; the speed of the sensed target; or the distance from the sensed target.

The terminal of the present disclosure may also report the sensing signal measurement result, and the plurality of possible parameters are provided, so that sensing may be performed by using the determined sensing node, thus improving the accuracy for sensing the sensed target.

In some implementations, the transmitting module 303 is further configured to: transmit the sensing request with at least one of the terminal, other access network device or the sensing function entity. Transmitting the sensing request includes at least one of receiving the sensing request or sending the sensing request. The sensing request is configured to request sensing the sensed target.

The present disclosure provides the plurality of methods for transmitting the sensing request, so that sensing may be performed by using the determined sensing node, thus improving the accuracy for sensing the sensed target.

In some implementations, the sensing request includes at least one of the service cell identifier or the tracking identifier of the terminal.

The present disclosure provides possible parameters included in the sensing request, which may be configured to determine the sensing node. As a result, sensing may be performed by using the determined sensing node, thus improving the accuracy for sensing the sensed target.

In some implementations, receiving the sensing request with the terminal based on at least one of the following: the random access procedure; the scheduling request; or the UL MAC CE.

The present disclosure provides the plurality of methods for receiving the sensing request with the terminal, and sensing is performed by using the determined sensing node, thus improving the accuracy for sensing the sensed target.

In some implementations, sending the sensing request with the terminal based on at least one of the following: the first DL MAC CE; the paging signal; or the first downlink control information.

The present disclosure provides the plurality of methods for sending the sensing request with the access network device, and sensing is performed by using the determined sensing node, thus improving the accuracy for sensing the sensed target.

In some implementations, in a case where the sensing node is the terminal, the transmitting module 303 is further configured to send indication information. The indication information is configured to indicate that the terminal is the sensing node.

The present disclosure may determine the sensing node via the indication information to be applicable to more scenarios. And sensing is performed by using the determined sensing node, thus improving the accuracy for sensing the sensed target.

In some implementations, the indication information includes the cell identifier.

According to the present disclosure, it is possible to indicate that the terminal is the sensing node via the cell identifier, so that sensing is performed by using the determined sensing node, thus improving the accuracy for sensing the sensed target.

In some implementations, the indication information includes at least one of the following: the broadcast information, where the broadcast information includes: the broadcast information carried on the PBCH, or the other system information carried on the PDSCH; the second DL MAC CE; or the second downlink control information.

The indication information of the present disclosure may include various information to support indicating the sensing node in various forms. As a result, sensing may be performed by using the determined sensing node, thus improving the accuracy for sensing the sensed target.

In some implementations, the broadcast information is the broadcast information corresponding to the at least one SSB identifier.

The present disclosure provides the form of expression of the first broadcast information to indicate the sensing node. As a result, sensing may be performed by using the determined sensing node, thus improving the accuracy for sensing the sensed target.

In some implementations, in a case where the sensing node is the access network device, the transmitting module 303 is further configured to: receive the sensing signal or the reference signal. The processing module 301 is further configured to determine the performance of the sensing signal or the performance of the reference signal. The processing module 301 is further configured to determine that the access network device is the sensing node based on the performance of the sensing signal or the performance of the reference signal meeting the performance condition.

According to the present disclosure, the sensing node suitable for transmitting the sensing signal is determined via the performance situation of the sensing signal or the reference signal, so that sensing is performed by using the determined sensing node, thus improving the accuracy for sensing the sensed target.

In some implementations, the performance condition is determined in at least one of the following: the configuration information received from the sensing function entity, or the default rule.

The present disclosure provides the plurality of methods for determining the performance condition, so that the terminal determines the sensing node suitable for transmitting the sensing signal according to the performance condition. As a result, sensing may be performed by using the determined sensing node, thus improving the accuracy for sensing the sensed target.

In some implementations, the sensing node includes at least one of the sensing signal sending node or the sensing signal receiving node. The access network device is at least one of the sensing signal sending node or the sensing signal receiving node.

The access network device of the present disclosure may be at least one of the sensing signal sending node or the sensing signal receiving node. As a result, sensing may be performed by using the determined sensing node, thus improving the accuracy for sensing the sensed target.

In some implementations, the performance of the sensing signal is the signal strength or the signal quality of the sensing signal. The performance of the reference signal is the signal strength or the signal quality of the reference signal.

The present disclosure provides the plurality of possible parameters of the performance of the sensing signal, so that sensing may be performed by using the determined sensing node, thus improving the accuracy for sensing the sensed target.

In some implementations, the sensing node includes at least one of the sensing signal sending node or the sensing signal receiving node. Determining the sensing node includes at least one of the following: determining that the access network device is the sensing signal sending node based on the sensing function entity, in a case where the sensing initiating node is the sensing function entity; determining that the access network device is the sensing signal sending node and the sensing signal receiving node based on the sensing function entity, in a case where the sensing initiating node is the sensing function entity; determining that the access network device is the sensing signal receiving node based on at least one of the sensing function entity or other access network device, in a case where the sensing initiating node is the sensing function entity, where the other access network device is the sensing signal sending node; determining that the access network device is the sensing signal sending node and the sensing signal receiving node based on at least one of the sensing function entity or the access network device, in a case where the sensing initiating node is the access network device; determining that the access network device is the sensing signal sending node based on at least one of the sensing function entity or the access network device, in a case where the sensing initiating node is the access network device; determining that the access network device is the sensing signal receiving node based on at least one of the sensing function entity or the access network device, in a case where the sensing initiating node is the access network device; or determining that the access network device is the sensing signal receiving node based on at least one of the sensing function entity or the other access network device, in a case where the sensing initiating node is other access network device.

The present disclosure provides the plurality of methods for determining the sensing node, so that sensing may be performed by using the determined sensing node, thus improving the accuracy for sensing the sensed target.

In some implementations, it is determined that the access network device is the sensing signal sending node based on at least one of the sensing function entity or the access network device in a case where the sensing initiating node is the access network device. The processing module 301 is further configured to determine that the other access network device is the sensing signal receiving node.

The present disclosure provides the plurality of methods for determining the sensing node, so that sensing may be performed by using the determined sensing node, thus improving the accuracy for sensing the sensed target.

In some implementations, in a case where the sensing initiating node is the terminal, the processing module 301 is further configured to determine that the access network device is the sensing node based on the serving cell of the terminal.

The present disclosure provides the plurality of methods for determining the sensing node, so that sensing may be performed by using the determined sensing node, thus improving the accuracy for sensing the sensed target.

In some implementations, the sensing mode for performing sensing includes at least one of the following: determining the access network device as the sensing signal sending node, and determining the terminal as the sensing signal receiving node; determining the access network device as the sensing signal receiving node, and determining the terminal as the sensing signal sending node; determining the first access network device as the sensing signal sending node, and determining the second access network device as the sensing signal receiving node, where the access network device is the first access network device or the second access network device; determining the access network device as the sensing signal sending node and the sensing signal receiving node; determining the terminal as the sensing signal sending node and the sensing signal receiving node; or determining the first terminal as the sensing signal sending node, and determining the second terminal as the sensing signal receiving node, where the terminal includes the first terminal and the second terminal.

The present disclosure is applicable to the plurality of different sensing mode scenarios to determine sensing nodes in the corresponding scenarios, so that sensing is performed by using the determined sensing node, thus improving the accuracy for sensing the sensed target.

As for the apparatus in the above embodiment, a specific mode in which each module executes operations has been described in detail in the embodiments of the method, which will not be described in detail here.

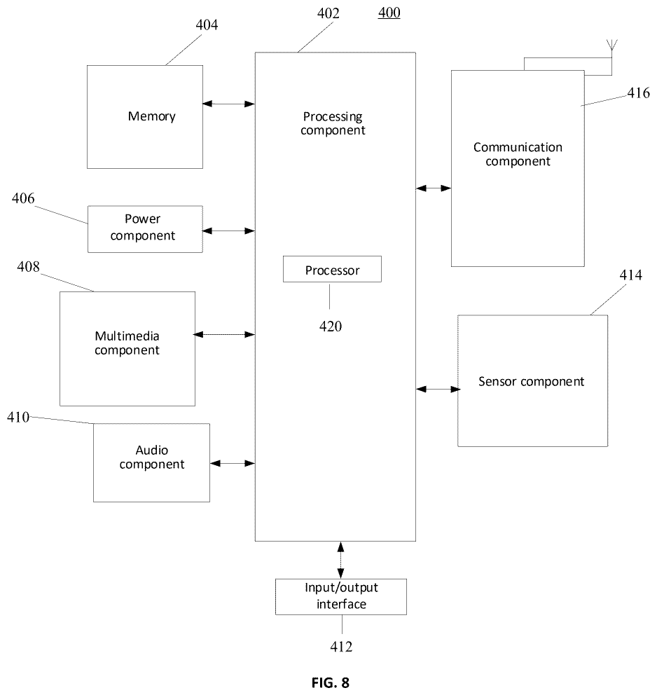

FIG. 8 is a schematic diagram of a communication sensing device, according to an example. For example, the device 400 may be any terminal such as a mobile phone, a computer, a digital broadcasting terminal, a messaging device, a game console, a tablet device, a medical device, a fitness device, or a personal digital assistant.

For example, at least one of the first device or the second device may be the terminal.

Referring to FIG. 8, the device 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls an overall operation of the device 400, such as operations associated with display, a telephone call, a data communication, a camera operation, and a recording operation. The processing component 402 may include one or more processors 420 to execute instructions to complete all or part of the steps of the above method. In addition, the processing component 402 may include one or more modules to facilitate interaction between the processing component 402 and other components. For example, the processing component 402 may include a multimedia module to facilitate interaction between the multimedia component 408 and the processing component 402.

The memory 404 is configured to store various types of data to support an operation at the device 400. Examples of the data include instructions for any application or method operating on the device 400, contact data, phonebook data, a message, a picture, a video, etc. The memory 404 may be implemented by any type of volatile or nonvolatile storage device or their combination, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or an optical disk.

The power component 406 provides power for various components of the device 400. The power component 406 may include a power management system, one or more power sources, and other components associated with generating, managing, and distributing power for the device 400.

The multimedia component 408 includes a screen providing an output interface between the device 400 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense touches, slides, and gestures on the touch panel. The touch sensor can not only sense the boundary of the touch or sliding operation, but also detect the duration and pressure related to the touch or sliding operation. In some embodiments, the multimedia component 408 includes at least one of a front camera or a rear camera. When the apparatus 400 is in an operation mode, such as a shooting mode or a video mode, at least one of the front camera or the rear camera may receive external multimedia data. Each front camera and rear camera may be a fixed optical lens system or have a focal length and optical zoom capability.

The audio component 410 is configured to at least one of output or input an audio signal. For example, the audio component 410 includes a microphone (MIC) configured to receive an external audio signal when the device 400 is in the operation mode, such as a call mode, a recording mode, and a speech recognition mode. The received audio signal may be further stored in the memory 404 or transmitted via the communication component 416. In some embodiments, the audio component 410 also includes a speaker for outputting an audio signal.

The I/O interface 412 provides an interface between the processing component 402 and a peripheral interface module. The peripheral interface module may be a keyboard, a click wheel, a button, etc. The buttons may include but are not limited to a home button, a volume button, and a start button, but they are not limited to a home button, a volume button, a start button, and a lock button.

The sensor component 414 includes one or more sensors for providing state evaluation of various aspects of the device 400. For example, the sensor component 414 may detect an open or closed state of the device 400, and the relative positioning of the component. For example, the component is the display and the keypad of the device 400, and the sensor component 414 may further detect: a change in the position of the device 400 or of a component of the device 400; the presence or absence of contact between the user and the device 400; an orientation, acceleration, or deceleration of the device 400; and a change in temperature of the device 400. The sensor component 414 may include a proximity sensor configured to detect the presence of a nearby object without any physical contact. The sensor component 414 may further include an optical sensor, such as a complementary metal-oxide-semiconductor (CMOS) or charge-coupled device (CCD image sensor), for use in imaging applications. In some embodiments, the sensor component 414 may further include an acceleration sensor, a gyroscope sensor, a magnetic sensor, a pressure sensor, or a temperature sensor.

The communication component 416 is configured to facilitate wired or wireless communications between the device 400 and other devices. The device 400 may access a wireless network based on a communication standard, such as Wi-Fi, 2G, or 3G, or their combination. In an example, the communication component 416 receives a broadcast signal or broadcast-related information from an external broadcast management system via a broadcast channel. In an example, the communication component 416 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an example, the device 400 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements for performing the above method.

In an example, a non-transitory computer-readable storage medium including instructions, such as the memory 404, including instructions, which can be executed by the processor 420 of the device 400 to complete the above method, is further provided. For example, the non-transitory computer-readable storage medium may be the ROM, a random access memory (RAM), a compact disc read-only memory (CD-ROM), a magnetic tape, a floppy disk, an optical data storage device, etc.

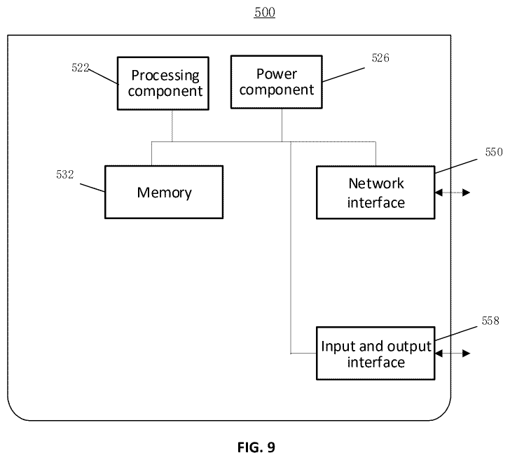

FIG. 9 is a schematic diagram of a communication sensing device according to another example. For example, the device 500 may be provided as the base station or a server. For example, at least one of the first device or the second device may be the access network device, such as the base station, where the base station may be the gNB; or the second device may be the sensing function entity. Referring to FIG. 9, the device 500 includes a processing component 522, which further includes one or more processors, and a memory resource represented by a memory 532 for storing instructions, such as application programs, that can be executed by the processing component 522. The applications stored in the memory 532 may include one or more modules, each corresponding to a set of instructions. In addition, the processing component 522 is configured to execute instructions to perform the above method.

The device 500 may further include a power component 526 configured to perform power management of the device 500, a wired or wireless network interface 550 configured to connect the device 500 to a network, and an input/output (I/O) interface 558. The device 500 can operate an operating system stored in the memory 532, such as Windows Server™, Mac OSX™, Unix™, Linux™, FreeBSD™, or the like.

According to the present disclosure, the sensing node suitable for transmitting the sensing signal is determined, so that sensing is performed by using the determined sensing node, thus improving accuracy for sensing the sensed target.

As used herein, the term processor may refer to one processor that performs the defined functions or a plurality of processors that collectively perform defined functions, such that the execution of the individual defined functions may be divided amongst such processors.

It can be further understood that “a plurality of” in the present disclosure refers to two or more, and other quantifiers are similar. “And/or” describes the association relationship of associated objects, which means that there can be three kinds of relationships, for example, A and/or B can mean that there are three kinds of situations: A exists alone, A and B exist together, and B exists alone. A character “/” universally indicates that front and back associated objects are in an “or” relationship. The singular forms “one,” “said,” and “the” are also intended to include the majority forms unless the context clearly indicates other meanings.

It can be further understood that the terms “first,” “second” and the like are configured to describe various information, but this information should not be limited to these terms. These terms are only configured to distinguish the same type of information from each other, and do not indicate a specific order or importance. In fact, the expressions “first” and “second” can be used interchangeably. For example, without departing from the scope of the present disclosure, first information may also be referred to as second information, and similarly, the second information may also be referred to as the first information.

It may be further understood that the meaning of the words “in a case where,” “if,” etc., involved in the present disclosure depends on the context as well as scenarios of actual use. For example, the words “in a case where” used here may be interpreted as “at the time of . . . ” or “when . . . ” or “in a case of” or “if”.

It can be further understood that in the embodiment of the present disclosure, although the operations are described in a specific order in the drawings, it should not be understood as requiring these operations to be performed in the specific order or serial order shown, or requiring all the operations shown to be performed to achieve the desired results. Multitasking and parallel processing may be advantageous in a particular environment.

Other implementation schemes of the present disclosure will be apparent to those skilled in the art from consideration of the specification and practice of the present disclosure here. The present application is intended to cover any variation, use, or adaptation of the present disclosure that follows the general principles of the present disclosure and includes common knowledge or customary technical means in the technical field that are not disclosed in the present disclosure.

It is to be understood that the present disclosure is not limited to the exact construction that has been described above and illustrated in the accompanying drawings, and that various modifications and changes may be made without departing from its scope. The scope of the present disclosure is merely limited by the appended claims.

1. A communication sensing method, performed by a terminal, comprising:
determining a sensing node; and
transmitting a sensing signal by using the sensing node, wherein the sensing signal is configured to sense a sensed target.

2. The method according to claim 1, wherein
in a case where the sensing node is the terminal, determining the sensing node comprises:
receiving the sensing signal or a reference signal sent by an access network device or other terminal,
determining a performance of the sensing signal or a performance of the reference signal, and
determining the sensing node based on the performance of the sensing signal or the performance of the reference signal meeting a performance condition; or
in the case where the sensing node is the terminal, determining the sensing node comprises:
receiving indication information sent by the access network device, the other terminal or a sensing function entity, wherein the indication information is configured to indicate that the terminal is the sensing node.

3. The method according to claim 2, wherein the performance condition is determined based on at least one of:
configuration information received from the sensing function entity,
configuration information received from the access network device, or
a default rule.

4. The method according to claim 2, wherein
the sensing node comprises at least one of a sensing signal sending node or a sensing signal receiving node, and
the terminal is at least one of the sensing signal sending node or the sensing signal receiving node.

5. The method according to claim 4, wherein, in a case where the terminal is the sensing signal receiving node, the method further comprises:
sending a sensing signal measurement result, wherein the sensing signal measurement result comprises at least one of:
a sensing signal identifier,
the performance of the sensing signal,
time of arrival of the sensing signal,
an angle of the sensing signal,
an angle of the sensed target,
a speed of the sensed target, or
a distance from the sensed target.

6. The method according to claim 2, wherein
the performance of the sensing signal is a signal strength or a signal quality of the sensing signal, and
the performance of the reference signal is a signal strength or a signal quality of the reference signal.

7. The method according to claim 2, further comprising:
transmitting a sensing request with at least one of the other terminal, the access network device or the sensing function entity, wherein transmitting the sensing request comprises at least one of sending the sensing request or receiving the sensing request, and the sensing request is configured to request sensing the sensed target;
sending the sensing signal or the reference signal, wherein the sensing signal or the reference signal is configured to determine that the other terminal or the access network device is the sensing node.

8. The method according to claim 7, wherein the sensing request comprises at least one of a service cell identifier or a tracking identifier of the terminal.

9. The method according to claim 7, wherein at least one of
sending the sensing request with the access network device based on at least one of:
a random access procedure,
a scheduling request, or
an uplink medium access control control element (UL MAC CE); or
receiving the sensing request with the access network based on at least one of:
first a downlink (DL) MAC CE,
a paging signal, or
first downlink control information; or
transmitting the sensing request with the other terminal based on at least one of:
a sidelink broadcast channel,
a first sidelink MAC CE, or
first sidelink control information.

10-12. (canceled)

13. The method according to claim 2, wherein
in a case where the indication information sent by the access network device or the sensing function entity is received, the indication information comprises a cell identifier; or
in a case where the indication information sent by the access network device is received, the indication information comprises at least one of:
first broadcast information, wherein the first broadcast information comprises: broadcast information carried on a physical broadcast channel (PBCH), or other system information carried on a physical downlink shared channel (PDSCH),
a second DL MAC CE, or
second downlink control information; or
in a case where the indication information sent by the other terminal is received, the indication information comprises at least one of:
second broadcast information, wherein the second broadcast information comprises: broadcast information carried on a PBCH of a sidelink, or other system information carried on a physical sidelink shared channel (PSSCH) of the sidelink,
the second sidelink MAC CE, or
the second sidelink control information.

14. (canceled)

15. The method according to claim 13, wherein
the first broadcast information is broadcast information corresponding to at least one synchronization signal and physical broadcast channel block (SSB) identifier; or
the second broadcast information is broadcast information corresponding to at least one sidelink SSB identifier.

16-18. (canceled)

19. The method according to claim 1, wherein a sensing mode for performing sensing comprises at least one of:
determining an access network device as a sensing signal sending node, and determining the terminal as a sensing signal receiving node,
determining the access network device as the sensing signal receiving node, and determining the terminal as the sensing signal sending node,
determining a first terminal as the sensing signal sending node, and determining a second terminal as the sensing signal receiving node, wherein the terminal is the first terminal or the second terminal, or
determining the terminal as the sensing signal sending node and the sensing signal receiving node.

20. A communication sensing method, performed by an access network device, comprising:
determining a sensing node; and
transmitting a sensing signal by using the sensing node, wherein the sensing signal is configured to sense a sensed target.

21. The method according to claim 20, wherein
a sensing function entity or the access network device is a sensing initiating node,
the sensing initiating node is a node that sends a sensing request, and
the sensing request is configured to request sensing the sensed target.

22. The method according to claim 20, wherein in a case where the sensing node is a terminal, the method further comprises one of:
sending the sensing signal or a reference signal, or
sending configuration information, wherein the configuration information is configured to configure a performance condition, and the performance condition is configured for the terminal to determine that the terminal is the sensing node based on performance of the sensing signal or performance of the reference signal meeting the performance condition.

23-33. (canceled)

34. The method according to claim 20, wherein,
in a case where the sensing node is the access network device, determining the sensing node comprises:
receiving the sensing signal or a reference signal,
determining a performance of the sensing signal or a performance of the reference signal, and
determining that the access network device is the sensing node based on the performance of the sensing signal or the performance of the reference signal meeting a performance condition; or
the sensing node comprises at least one of a sensing signal sending node or a sensing signal receiving node, and determining the sensing node comprises at least one of:
determining that the access network device is the sensing signal sending node based on a sensing function entity, in a case where a sensing initiating node is the sensing function entity,
determining that the access network device is the sensing signal sending node and the sensing signal receiving node based on the sensing function entity, in a case where the sensing initiating node is the sensing function entity,
determining that the access network device is the sensing signal receiving node based on at least one of the sensing function entity or other access network device, in a case where the sensing initiating node is the sensing function entity, wherein the other access network device is the sensing signal sending node,
determining that the access network device is the sensing signal sending node and the sensing signal receiving node based on at least one of the sensing function entity or the access network device, in a case where the sensing initiating node is the access network device,
determining that the access network device is the sensing signal sending node based on at least one of the sensing function entity or the access network device, in a case where the sensing initiating node is the access network device,
determining that the access network device is the sensing signal receiving node based on at least one of the sensing function entity or the access network device, in a case where the sensing initiating node is the access network device, or
determining that the access network device is the sensing signal receiving node based on at least one of the sensing function entity or the other access network device, in a case where the sensing initiating node is the other access network device; or
in a case where the sensing initiating node is a terminal, determining the sensing node comprises:
determining that the access network device is the sensing node based on a serving cell of the terminal.

35-38. (canceled)

39. The method according to claim 3438, wherein determining that the access network device is the sensing signal sending node based on at least one of the sensing function entity or the access network device, in a case where the sensing initiating node is the access network device, and the method further comprises:
determining that the other access network device is the sensing signal receiving node.

40. (canceled)

41. The method according to claim 20, wherein a sensing mode for performing sensing comprises at least one of:
determining the access network device as a sensing signal sending node, and determining a terminal as a sensing signal receiving node,
determining the access network device as the sensing signal receiving node, and determining the terminal as the sensing signal sending node,
determining a first access network device as the sensing signal sending node, and determining a second access network device as the sensing signal receiving node, wherein the access network device is the first access network device or the second access network device,
determining the access network device as the sensing signal sending node and the sensing signal receiving node,
determining the terminal as the sensing signal sending node and the sensing signal receiving node, or
determining a first terminal as the sensing signal sending node, and determining a second terminal as the sensing signal receiving node, wherein the terminal comprises the first terminal and the second terminal.

42-43. (canceled)

44. A communication sensing device, comprising:
one or more processors; and
a memory that stores processor-executable instructions, and
wherein the processor-executable instructions, when collectively executed by the one or more processors, cause the communication sensing device to:
determine a sensing node; and
transmit a sensing signal by using the sensing node, wherein the sensing signal is configured to sense a sensed target.

45. (canceled)

46. A non-transitory computer-readable storage medium-comprising instructions, when executed by a processor of the terminal, cause the terminal to perform the method according to claim 1.

47. (canceled)
